(19) United States
(12) Patent Application Publication
(10) Pub. No.: US 2014/0138584 A1
(43) Pub. Date: May 22, 2014

(54) Polymer-Soap Compositions and Methods of Making and Using the Same

(71) Applicant: The Procter & Gamble Company, Cincinnati, OH (US)

(72) Inventors: Eric Bryan BOND, Maineville, OH (US); Isao NODA, Fairfield, OH (US); William Maxwell ALLEN, Jr., Liberty Twp, OH (US); Michael Matthew SATKOWSKI, Oxford, OH (US)

(73) Assignee: The Procter & Gamble Company, Cincinnati, OH (US)

(21) Appl. No.: 14/085,715

(22) Filed: Nov. 20, 2013

Related U.S. Application Data
(60) Provisional application No. 61/728,731, filed on Nov. 20, 2012.

(51) Int. Cl. C11D 13/10

(52) U.S. Cl. CPC C11D 13/10
USPC 252/367.1

(57) ABSTRACT

Polymer-soap compositions comprising intimate admixtures of thermoplastic polymer and soap. Methods of making and using polymer-soap compositions.

### FIELD OF THE INVENTION

The present invention relates to polymer-soap compositions comprising intimate admixtures of thermoplastic polymer and soap. The present invention also relates to methods of making and using polymer-soap compositions.

### BACKGROUND OF THE INVENTION

Thermoplastic polymers are used in a wide variety of applications. However, compared to other polymer species, thermoplastic polymers (e.g., polypropylene and polyethylene) can pose greater formulation challenges when forming, for example, fibers. This is because the material and processing requirements for fiber production are much more stringent than those for other forms, for example, films. For fiber production, polymer melt flow characteristics are more demanding on the material's physical and rheological properties vs. other polymer processing methods. Also, the local shear/extensional rate and shear rate are much greater in fiber production than other processes.

Moreover, high molecular weight thermoplastic polymers cannot be easily or effectively spun into fine fibers. When spinning very fine fibers, small defects, slight inconsistencies, or slight phase incompatibilities in the melt are not acceptable for a commercially viable process. Given their availability and potential strength improvement, it would be desirable to provide a way to easily and effectively spin such high molecular weight polymers. Similar issues exist with processing thermoplastic polymers for injection molding and films.

Most thermoplastic polymers, such as polyethylene, polypropylene, and polyethylene terephthalate, are derived from monomers (e.g., ethylene, propylene, and terephthalic acid, respectively) that are obtained from non-renewable, fossil-based resources (e.g., petroleum, natural gas, and coal). Accordingly, the price and availability of these resources ultimately have a significant impact on the price of these polymers. As the worldwide price of fossil-based resources escalates, so does the price of materials made from these polymers.

Furthermore, many consumers are averse to purchasing products that are derived solely from non-renewable, fossil-based resources. Some of their concerns are based on environmental sustainability issues, for instance, while others are based on the perception of petrochemical-derived products as “unnatural” or not environmentally friendly.

Thermoplastic polymers are often incompatible with, or have poor miscibility with, desired additives (e.g., waxes, pigments, organic dyes, perfumes). This incompatibility can necessitate adding excessive additive in comparison to what would otherwise be necessary in order to attain the desired result. Accordingly, it would be desirable to address this deficiency.

Utilizing polypropylene as only a minor component, existing art has combined polypropylene compositions with additives and/or diluents to produce materials having very open, microporous structures with pore sizes greater than 10 μm. In all of the cases noted herein, the diluent as described is removed to produce the final porous (e.g., cellular) structure. Before diluent removal, the structures are unacceptably oily from the excessive diluent required to produce the desired open structure. Removing the diluents can not only necessitate additional processing and waste disposal, but also results in the removal of desired additives such as dyes, pigments, and/or perfumes.

For example, U.S. Pat. No. 3,093,612 describes the combination of polypropylene with various fatty acids where the fatty acid is removed. The scientific paper J. Apply. Polym. Sci 82 (1) pp. 169-177 (2001) discloses use of diluents on polypropylene for thermally induced phase separation to produce an open and large cellular structure but at low polymer ratio, where the diluent is subsequently removed from the final structure. The scientific paper J. Apply. Polym. Sci 105 (4) pp. 2000-2007 (2007) discloses microporous membranes produced via thermally induced phase separation with dibutyl phthalate and soy bean oil mixtures, with a minor component of polypropylene. The diluent is removed in the final structure. The scientific paper Journal of Membrane Science 108 (1-2) pp. 25-36 (1995) discloses hollow fiber microporous membranes produced using soy bean oil and polypropylene mixtures, with a minor component of polypropylene and using thermally induced phase separation to produce the desired membrane structure. The diluent is removed in the final structure.

Thus, a need exists for compositions of thermoplastic polymers that allow for use of higher molecular weight and/or decreased non-renewable resource-based materials, and/or better incorporation of additives, such as perfumes and dyes. A still further need is for compositions that do not require the removal of diluents, and/or that deliver renewable materials in the final product.

### SUMMARY OF THE INVENTION

In one aspect, the present invention provides a polymer-soap composition comprising an intimate admixture of: (a) a thermoplastic polymer; and (b) a soap. The soap has a droplet size of less than 10 μm within the solid thermoplastic polymer. Alternatively, the droplet size can be less than 5 μm, less than 1 μm, or less than 500 nm. The composition can comprise, based upon the total weight of the composition, from 5 wt % to 60 wt % soap, from 8 wt % to 40 wt % soap, or from 10 wt % to 30 wt % soap.

The soap comprises a metal salt of fatty acid. The metal used to make the soap can be selected from group 1, 2, 3, 4, 5, 6, 7, 8, 9, 10, 11, 12, 13, 14, 15, 16 of the periodic table of the elements using the IUPAC naming system implemented in 1988. The fatty acid can be selected from the group consisting of carbon-12 to carbon-22 aliphatic chain carboxylic acids. Exemplary soaps include calcium stearate, magnesium stearate, zinc stearate, and combinations thereof.

The thermoplastic polymer can comprise, for example, a polyolefin, a polyester, a polyamide, copolymers thereof, or combinations thereof. Further examples of thermoplastic polymer include polypropylene, polyethylene, polypropylene co-polymer, polyethylene co-polymer, polyethylene terephthalate, polybutylene terephthalate, polylactic acid, polyhydroxyalkanoates, polyamide-6, polyamide-6,6, or combinations thereof.

In some compositions, the thermoplastic polymer comprises polypropylene. For instance, the thermoplastic polymer can comprise from 1% to 100% polypropylene, greater than 50% polypropylene, from 55% to 100% polypropylene, from 60% to 100% polypropylene, or from 60% to 95% polypropylene, based upon the total weight of thermoplastic polymer present in the composition. The polypropylene can have, for example, a weight average molecular weight of 10 kDa to 1,000 kDa, and a melt flow index of greater than 0.25 g/10 m, or 0.25 g/10 min to 2000 g/10 m, or from 1 g/10 min to 500 g/10 min, or from 5 g/10 min to 250 g/10 min, or from 5 g/10 min to 100 g/10 min.

The presence of the soap in the thermoplastic polymer-soap composition can also act as a compatibilizer with other thermoplastic polymers not normally compatible directly with one another (e.g., polypropylene and polylactic acid). As used herein, the terms “thermoplastic polymer-soap” and “polymer-soap” are used interchangeably.

The polymer-soap composition can further comprise an additive, desirably an additive that is soap soluble or soap dispersible. Alternatively, the additive can be thermoplastic polymer dispersible. For example, the additive can be a perfume, dye, pigment, nanoparticle, antistatic agent, filler, or combinations thereof. Other additives can include nucleating agents.

Further, the thermoplastic polymer can be sourced from bio-based materials. For example, the polymer-soap composition can comprise greater than 10%, or greater than 50%, or from 30-100%, or from 1-100% bio-based materials, based upon the total weight of the polymer-soap composition.

The polymer-soap composition can be made by a method comprising the steps of: (a) mixing, in a molten state, the thermoplastic polymer and the soap to form an intimate admixture; and (b) cooling the intimate admixture in 10 seconds or less to a temperature equal to or less than the solidification temperature of the thermoplastic polymer, which for some thermoplastic polymer compositions is a temperature of 50° C. or less, to form a solid polymer-soap composition. The mixing step comprises mixing at a shear rate greater than 10 s⁻¹, or greater than 30 s⁻¹, or from 10 to 10,000 s⁻¹, or from 30 to 10,000 s⁻¹ depending on the forming method (e.g. fiber spinning, film casting/blowing, injection molding, or bottle blowing), to form the intimate admixture. Any suitable mixing device can be used such as, for example, an extruder (e.g., single screw or twin screw). Further, the method desirably does not comprise the step of removing additive or diluent.

The method can additionally comprise other steps, such as the step of pelletizing the admixture. The pelletizing step can occur before, during, or after the cooling step.

### BRIEF DESCRIPTION OF THE DRAWINGS

For a more complete understanding of the disclosure, reference should be made to the following detailed description and accompanying drawing wherein:

FIG. 1 is a plot of measured viscosity vs. shear for unmodified polypropylene and the polymer-soap compositions of Examples 1-3.

FIG. 2 is the polymer-soap composition of Example 1 that contains 15 wt % magnesium stearate.

FIG. 3 is the polymer-soap composition of Example 2 that contains 15 wt % calcium stearate.

FIG. 4 is the polymer-soap composition of Example 3 that contains 15 wt % zinc stearate.

FIG. 5 is the polymer-soap composition of Example 4 that contains 30 wt % zinc stearate.

While the disclosed invention is susceptible to embodiments in various forms, there are illustrated in the drawings (and will hereafter be described) specific embodiments of the invention, with the understanding that the disclosure is intended to be illustrative, and is not intended to limit the invention to the specific embodiments described and illustrated herein.

### DETAILED DESCRIPTION OF THE INVENTION

The polymer-soap compositions herein comprise an intimate admixture of: (a) a thermoplastic polymer; and (b) a soap. The term “intimate admixture” refers to the physical relationship between the soap and the thermoplastic polymer, wherein the soap is dispersed within the thermoplastic polymer. As used herein, the term “admixture” refers to the intimate admixture of the present invention, and not an “admixture” in the more general sense of a standard mixture of materials.

The soap can comprise a metal salt. For instance, the soap can comprise calcium stearate, magnesium stearate, zinc stearate, or combinations thereof. Further, the soap can comprise a lipid moiety selected from the group consisting of a monoglyceride, diglyceride, triglyceride, fatty acid, fatty alcohol, esterified fatty acid, epoxidized lipid, maleated lipid, hydrogenated lipid, alkyd resin derived from a lipid, sucrose polyester, and combinations thereof.

The thermoplastic polymer can comprise, for example, a polyolefin, a polyester, a polyamide, copolymers thereof, or combinations thereof. Further examples of thermoplastic polymer include polypropylene, polyethylene, polypropylene co-polymer, polyethylene co-polymer, polyethylene terephthalate, polybutylene terephthalate, polylactic acid, polyhydroxyalkanoates, polyamide-6, polyamide-6,6, or combinations thereof.

In some compositions, the thermoplastic polymer comprises polypropylene. For instance, the thermoplastic polymer can comprise from 1% to 100% polypropylene, greater than 50% polypropylene, from 55% to 100% polypropylene, from 60% to 100% polypropylene, or from 60% to 95% polypropylene, based upon the total weight of thermoplastic polymer present in the composition. The polypropylene can have, for example, a weight average molecular weight of 10 kDa to 1,000 kDa, and a melt flow index of 0.25 g/10 min to 2000 g/10 min, or from 1 g/10 min to 500 g/10 min, or from 5 g/10 min to 250 g/10 min, or from 5 g/10 min to 100 g/10 min.

When the soap is dispersed within the thermoplastic polymer such that the soap droplet size is less than 10 μm, the soap and the polymer are, by definition herein, in “intimate admixture.” The droplet size of the soap within the thermoplastic polymer is a parameter that indicates the level of dispersion of the soap within the thermoplastic polymer. The smaller the droplet size, the higher the dispersion of the soap within the thermoplastic polymer. Conversely, the larger the droplet size the lower the dispersion of the soap within the thermoplastic polymer.

The soap herein has a droplet size of less than 10 μm within the solid thermoplastic polymer. Alternatively, the droplet size can be less than 5 μm, less than 1 μm, or less than 500 nm. The composition can comprise, based upon the total weight of the composition, from 5 wt % to 60 wt % soap, from 8 wt % to 40 wt % soap, or from 10 wt % to 30 wt % soap.

One exemplary way to achieve a suitable dispersion of the soap within the thermoplastic polymer such that they are in intimate admixture is mixing, in a molten state, the thermoplastic polymer and the soap at a sufficient shear rate. The thermoplastic polymer is melted (e.g., exposed to temperatures greater than the thermoplastic polymer's solidification temperature) to provide the molten thermoplastic polymer and mixed with the soap. The thermoplastic polymer can be melted prior to addition of the soap or can be melted in the presence of the soap. It should be understood that when the thermoplastic polymer is melted, the temperature is sufficient that the soap can also be in a liquid crystalline, softened or in the molten state. The term soap as used herein can refer to the component either in the solid (optionally crystalline) state, liquid crystalline, softened or in the molten state, depending on the temperature. It is not required that the soap be solidified at a temperature at which the polymer is solidified. For example, polypropylene is a semi-crystalline solid at 90° C., which is above the melting point of some soap or soap mixtures.

The soap and molten thermoplastic polymer can be mixed using any mechanical means capable of providing the necessary shear rate to result in a composition as disclosed herein. The thermoplastic polymer and soap can be mixed, for example, at a shear rate greater than 10 s⁻¹, or greater than 30 s⁻¹, or from 10 to 10,000 s⁻¹, or from 30 to 10,000 s⁻¹ depending on the forming method (e.g. fiber spinning, film casting/blowing, injection molding, or bottle blowing), to form the intimate admixture The higher the shear rate of the mixing, the greater the dispersion of the soap in the composition as disclosed herein. Thus, the dispersion can be controlled by selecting a particular shear rate during formation of the composition. Non-limiting examples of suitable mechanical mixing means include a mixer, such as a Haake batch mixer, and an extruder (e.g., a single- or twin-screw extruder).

The polymer-soap composition can further comprise an additive, desirably an additive that is soap soluble or soap dispersible. For example, the additive can be a perfume, dye, pigment, nanoparticle, antistatic agent, filler, or combinations thereof. Other additives can include nucleating agents.

Further, the thermoplastic polymer, the soap, and/or the polymer-soap composition can be sourced from renewable materials (e.g., bio-based). For example, the polymer-soap composition can comprise greater than 10%, or greater than 50%, or from 30-100%, or from 1-100% renewable materials, based upon the total weight of the polymer-soap composition.

After mixing, the admixture of molten thermoplastic polymer and soap is then rapidly (e.g., in less than 10 seconds) cooled to a temperature lower than the solidification temperature (either via traditional thermoplastic polymer crystallization or passing below the polymer glass transition temperature) of the thermoplastic polymer. The admixture can be cooled to less than 200° C., less than 150° C., less than 100° C. less than 75° C., less than 50° C., less than 40° C., less than 30° C., less than 20° C., less than 15° C., less than 10° C., or to a temperature of 0° C. to 30° C., 0° C. to 20° C., or 0° C. to 10° C. For example, the mixture can be placed in a low temperature liquid (e.g., the liquid is at or below the temperature to which the mixture is cooled) or gas. The liquid can be ambient or controlled temperature water. The gas can be ambient air or controlled temperature and humidity air. Any quenching media can be used so long as it cools the admixture rapidly. Additional liquids such as oils, alcohols and ketones can be used for quenching, along with mixtures comprising water (sodium chloride for example) depending on the admixture composition. Additional gases can be used, such as carbon dioxide and nitrogen, or any other component naturally occurring in atmospheric temperature and pressure air.

Further, the method for making the polymer-soap composition desirably does not comprise the step of removing additive or diluent.

Optionally, the composition can be made in the form of pellets, which can be used as-is or stored for future use, such as for further processing into the final usable form (e.g., fibers, films, and/or molded articles). The pelletizing step can occur before, during, or after the cooling step. For instance, the pellets can be formed by strand cutting or underwater pelletizing. In strand cutting, the composition is rapidly quenched (generally in a time period much less than 10 seconds) then cut into small pieces. In underwater pelletizing, the mixture is cut into small pieces and simultaneously or immediately thereafter placed in the presence of a low temperature liquid that rapidly cools and solidifies the mixture to form the pelletized composition. Such pelletizing methods are well understood by the ordinarily skilled artisan. Pellet morphologies can be round or cylindrical, and desirably have no dimension larger than 10 mm, or less than 5 mm, or no dimension larger than 2 mm. Alternatively, the admixture (the terms “admixture” and “mixture” are used interchangeably herein) can be used whilst mixed in the molten state and formed directly into fibers or other suitable forms, for example, films, and molded articles.

### Thermoplastic Polymers

Thermoplastic polymers, as used herein, are polymers that melt and then, upon cooling, crystallize or harden, but can be re-melted upon further heating. Suitable thermoplastic polymers used herein have a melting temperature from 60° C. to 300° C., from 80° C. to 250° C., or from 100° C. to 215° C.

The thermoplastic polymers can be derived from renewable resources or from fossil-based materials. The thermoplastic polymers derived from renewable resources are bio-based, for example such as bio-produced ethylene and propylene monomers used in the production of polypropylene and polyethylene. These material properties are essentially identical to fossil-based product equivalents, except for the presence of carbon-14 in the bio-based thermoplastic polymer.

As used herein, a “renewable resource” is one that is produced by a natural process at a rate comparable to its rate of consumption (e.g., within a 100 year time frame). The resource can be replenished naturally or via engineered agricultural techniques. Non-limiting examples of renewable resources include plants (e.g., sugar cane, beets, corn, potatoes, citrus fruit, woody plants, lignocellulosics, hemicellulosics, cellulosic waste), animals, fish, bacteria, fungi, and forestry products. These resources can be naturally occurring, hybrids, or genetically engineered organisms. Natural resources such as crude oil, coal, natural gas, and peat, which take longer than 100 years to form, are not considered renewable resources.

Renewable and fossil based thermoplastic polymers can be combined together in the present invention in any ratio, depending on cost and availability. Recycled thermoplastic polymers can also be used, alone or in combination with renewable and/or fossil derived thermoplastic polymers. The recycled thermoplastic polymers can be pre-conditioned to remove any unwanted contaminants prior to compounding or they can be used during the compounding and extrusion process, as well as simply left in the admixture. These contaminants can include trace amounts of other polymers, pulp, pigments, inorganic compounds, organic compounds and other additives typically found in processed polymeric compositions. The contaminants should not negatively impact the final performance properties of the admixture, for example, causing spinning breaks during a fiber spinning process.

For example, the thermoplastic polymer can comprise greater than 10% renewable material, or greater than 50%, or from 30-100%, or from 1-100% renewable material (i.e., renewable biobased materials), based upon the total weight of thermoplastic polymer present.

To determine the level of renewable materials present in an unknown composition (e.g., in a product made by a third party), ASTM D6866 test method B can be used to measure the biobased content by measuring the amount of carbon-14 in the product. Materials that come from biomass (i.e. renewable sources) have a well-characterized amount of carbon-14 present, whereas those from fossil sources do not contain carbon-14. Thus, the carbon-14 present in the product is correlated to its biobased content.

The molecular weight of the thermoplastic polymer is sufficiently high to enable entanglement between polymer molecules and yet low enough to be melt extrudable. Addition of the soap into the composition allows for compositions containing higher molecular weight thermoplastic polymers to be melt processed, compared to compositions without a soap. Thus, suitable thermoplastic polymers can have weight average molecular weights of 1000 kDa or less, 5 kDa to 800 kDa, 10 kDa to 700 kDa, or 20 kDa to 400 kDa. The weight average molecular weight is determined by the specific ASTM method for each polymer, but is generally measured using either gel permeation chromatography (GPC) or from solution viscosity measurements. The thermoplastic polymer weight average molecular weight should be determined before addition into the admixture.

Suitable thermoplastic polymers generally include polyolefins, polyesters, polyamides, copolymers thereof, and combinations thereof. The thermoplastic polymer can be selected from the group consisting of polypropylene, polyethylene, polypropylene co-polymer, polyethylene co-polymer, polyethylene terephthalate, polybutylene terephthalate, polylactic acid, polyhydroxyalkanoates, polyamide-6, polyamide-6,6, and combinations thereof.

More specifically, however, the thermoplastic polymers desirably include polyolefins such as polyethylene or copolymers thereof, including low density, high density, linear low density, or ultra low density polyethylenes such that the polyethylene density ranges from 0.90 grams per cubic centimeter to 0.97 grams per cubic centimeter, or from 0.92 to 0.95 grams per cubic centimeter. The density of the polyethylene is determined by the amount and type of branching and depends on the polymerization technology and co-monomer type. Polypropylene and/or polypropylene copolymers, including atactic polypropylene, isotactic polypropylene, syndiotactic polypropylene, or combinations thereof can also be used. Polypropylene copolymers, especially ethylene, can be used to lower the melting temperature and improve properties. These polypropylene polymers can be produced using metallocene and Ziegler-Natta catalyst systems. These polypropylene and polyethylene compositions can be combined together to custom engineer end-use properties. Polybutylene is also a useful polyolefin.

Other suitable polymers include polyamides or copolymers thereof, such as Nylon 6, Nylon 11, Nylon 12, Nylon 46, Nylon 66; polyesters or copolymers thereof, such as maleic anhydride polypropylene copolymer, polyethylene terephthalate; olefin carboxylic acid copolymers such as ethylene/acrylic acid copolymer, ethylene/maleic acid copolymer, ethylene/methacrylic acid copolymer, ethylene/vinyl acetate copolymers or combinations thereof; polyacrylates, polymethacrylates, and their copolymers such as poly(methyl methacrylates).

Other nonlimiting examples of suitable polymers include polycarbonates, polyvinyl acetates, poly(oxymethylene), styrene copolymers, polyacrylates, polymethacrylates, poly(methyl methacrylates), polystyrene/methyl methacrylate copolymers, polyetherimides, polysulfones, or combinations thereof. In some compositions, thermoplastic polymers include polypropylene, polyethylene, polyamides, polyvinyl alcohol, ethylene acrylic acid, polyolefin carboxylic acid copolymers, polyesters, and combinations thereof.

More specifically, however, the thermoplastic polymers can desirably include polyolefins such as polyethylene or copolymers thereof, including low, high, linear low, or ultra low density polyethylenes, polypropylene or copolymers thereof, including atactic polypropylene; isotactic polypropylene, metallocene isotactic polypropylene, polybutylene or copolymers thereof; polyamides or copolymers thereof, such as Nylon 6, Nylon 11, Nylon 12, Nylon 46, Nylon 66; polyesters or copolymers thereof, such as maleic anhydride polypropylene copolymer, polyethylene terephthalate; olefin carboxylic acid copolymers such as ethylene/acrylic acid copolymer, ethylene/maleic acid copolymer, ethylene/methacrylic acid copolymer, ethylene/vinyl acetate copolymers or combinations thereof; polyacrylates, polymethacrylates, and their copolymers such as poly(methyl methacrylates).

Other nonlimiting examples of polymers include polycarbonates, polyvinyl acetates, poly(oxymethylene), styrene copolymers, polyacrylates, polymethacrylates, poly(methyl methacrylates), polystyrene/methyl methacrylate copolymers, polyetherimides, polysulfones, or combinations thereof. In some compositions, thermoplastic polymers include polypropylene, polyethylene, polyamides, polyvinyl alcohol, ethylene acrylic acid, polyolefin carboxylic acid copolymers, polyesters, and combinations thereof.

Biodegradable thermoplastic polymers also are contemplated for use herein. Biodegradable materials are susceptible to being assimilated by microorganisms, such as molds, fungi, and bacteria when the biodegradable material is buried in the ground or otherwise contacts the microorganisms (including contact under environmental conditions conducive to the growth of the microorganisms). Suitable biodegradable polymers also include those biodegradable materials that are environmentally-degradable using aerobic or anaerobic digestion procedures, or by virtue of being exposed to environmental elements such as sunlight, rain, moisture, wind, temperature, and the like. The biodegradable thermoplastic polymers can be used individually or as a combination of biodegradable or non-biodegradable polymers. Biodegradable polymers include polyesters containing aliphatic components. Among the polyesters are ester polycondensates containing aliphatic constituents and poly(hydroxycarboxylic) acid. The ester polycondensates include diacids/diol aliphatic polyesters such as polybutylene succinate, polybutylene succinate co-adipate, aliphatic/aromatic polyesters such as terpolymers made of butylene diol, adipic acid and terephthalic acid. The poly(hydroxycarboxylic) acids include lactic acid based homopolymers and copolymers, polyhydroxybutyrate (PHB), or other polyhydroxyalkanoate homopolymers and copolymers. Such polyhydroxyalkanoates include copolymers of PHB with higher chain length monomers, such as C₆-C₁₂, and higher, polyhydroxyalkanaotes, such as those disclosed in U.S. Pat. Nos. RE 36,548 and 5,990,271.

An example of a suitable commercially available polylactic acid is NATUREWORKS™ from Cargill Dow and LACEA™ from Mitsui Chemical. An example of a suitable commercially available diacid/diol aliphatic polyester is the polybutylene succinate/adipate copolymers sold as BIONOLLE™ 1000 and BIONOLLE™ 3000 from the Showa High Polymer Company, Ltd. (Tokyo, Japan). An example of a suitable commercially available aliphatic/aromatic copolyester is the poly(tetramethylene adipate-co-terephthalate) sold as EASTAR BIO™ Copolyester from Eastman Chemical or ECOFLEX™ from BASF.

Non-limiting examples of suitable commercially available polypropylene or polypropylene copolymers include Basell Profax PH-835™ (a 35 melt flow rate Ziegler-Natta isotactic polypropylene from Lyondell-Basell), Basell Metocene MF-650W™ (a 500 melt flow rate metallocene isotactic polypropylene from Lyondell-Basell), Polybond 3200™ (a 250 melt flow rate maleic anhydride polypropylene copolymer from Crompton), Exxon Achieve 3854™ (a 25 melt flow rate metallocene isotactic polypropylene from Exxon-Mobil Chemical), and Mosten NB425™ (a 25 melt flow rate Ziegler-Natta isotactic polypropylene from Unipetrol). Other suitable polymers may include; Danimer 27510™ (a polyhydroxyalkanoate polypropylene from Danimer Scientific LLC), Dow Aspun 6811ATM (a 27 melt index polyethylene polypropylene copolymer from Dow Chemical), and Eastman 9921™ (a polyester terephthalic homopolymer with a nominally 0.81 intrinsic viscosity from Eastman Chemical).

The thermoplastic polymer component can be a single polymer species as described herein or a blend of two or more thermoplastic polymers. If the polymer is polypropylene, the thermoplastic polymer can have a melt flow index of greater than 0.25 g/10 min, or 0.25 g/10 min to 2000 g/10 min, or from 1 g/10 min to 500 g/10 min, or from 5 g/10 min to 250 g/10 min, or from 5 g/10 min to 100 g/10 min, as measured by ASTM D-1238, used for measuring polypropylene.

### Soaps

The term “soap” as used herein refers to fatty acid metal salts that have a softening, phase transition or melting point exhibited by a reduction in crystallinity or an endothermic process upon heating as measured in a differential scanning calorimeter (DSC) from 20° C. to 300° C. For example, the fatty acid salt can be a metal salt having a melting point above 70° C., or above 100° C., or above 140° C. The soap can have a melting point that is lower than the melting temperature of the thermoplastic polymer in the composition.

The soap can be present in the composition at a weight percent of 5 wt % to 60 wt %, based upon the total weight of the composition. Other contemplated wt % ranges of soap include 8 wt % to 40 wt %, 10 wt % to 30 wt %, 10 wt % to 20 wt %, or from 12 wt % to 18 wt %, based upon the total weight of the composition.

The soap can be dispersed within the thermoplastic polymer such that the soap has a droplet size of less than 10 μm, less than 5 μm, less than 1 μm, or less than 500 nm within the thermoplastic polymer. As used herein, the soap and the polymer form an “intimate admixture” when the soap has a droplet size less than 10 μm within the thermoplastic polymer. The analytical method for determining droplet size is set forth herein.

The soap can comprise metal salts of fatty acid, such as magnesium stearate, calcium stearate, zinc stearate or combinations thereof. In some embodiments, other soaps may include those derived from metal salts of the following metals found in group 1, 2, 3, 4, 5, 6, 7, 8, 9, 10, 11, 12, 13, 14, 15, 16 of the periodic table of the elements using the IUPAC naming system implemented in 1988; sodium, potassium, rubidium, cesium, silver, cobalt, nickel, copper, manganese, iron, chromium, lithium, lead, thallium, mercury, thorium, and beryllium are examples of some of these metals but are not limited to them. The fatty acid can be selected from a group consisting of carbon-12 to carbon-22 aliphatic chain carboxylic acids, alternatively from carbon-14 to carbon-18. Non-limiting examples of specific fatty acids contemplated include lauric acid, myristic acid, palmitic acid, stearic acid, and mixtures thereof. Exemplary soaps include magnesium stearate, calcium stearate, zinc stearate or combinations thereof. The amount of other metal salt soaps should be less than 50% of the amount of the primary soap, by weight of the primary soap present, or less than 25%, or less than 10%, or less than 5%.

The soap can contain fatty acids derived from various sources. The fatty acid can have a variety of chain lengths. The carbon chain lengths are mostly between C12 and C18, but may contain small fractions (e.g., less than 50 wt %) of other chain lengths. These fatty acids have common names of lauric, myristic, palmitic, stearic, oleic, linoleic, linolenic acids, and includes mixtures thereof. These fatty acids can be saturated, unsaturated, have varying degrees of saturation (e.g., partially saturated), or any variations or combinations thereof. For example, the fatty acids can comprise saturated fatty acids, such as stearic acid. These fatty acids can also be functionalized fatty acids, such as those epoxidized and/or hydroxylated. An example of a functionalized fatty acid is epoxidized oleic acid. An exemplary functionalized fatty acid also includes 12-hydroxystearic acid.

If one desires to determine the percentage of soap present in an unknown polymer-soap composition (e.g., in a product made by a third party), the amount of soap can be determined via a gravimetric weight loss method. The solidified mixture is broken apart to produce a mixture of particles with the narrowest dimension no greater than 1 mm (i.e. the smallest dimension can be no larger than 1 mm), the mixture is weighed, and then placed into acetone at a ratio of 1 g of mixture per 100 g of acetone using a refluxing flask system. The acetone and pulverized mixture is heated at 60° C. for 20 hours. The solid sample is removed and air dried for 60 minutes and a final weight determined The equation for calculating the weight percent soap is:

weight % soap=([initial weight of mixture−final weight of mixture]/[initial weight of mixture])×100%

As used herein, the terms “wax” and “oil” describe the sources of the fatty acids used to produce the soap. Non-limiting examples of fatty acids used to produce the soap used in the present invention include beef tallow, castor wax, coconut wax, coconut seed wax, corn germ wax, cottonseed wax, fish wax, linseed wax, olive wax, oiticica wax, palm kernel wax, palm wax, palm seed wax, peanut wax, rapeseed wax, safflower wax, soybean wax, sperm wax, sunflower seed wax, tall wax, tung wax, whale wax, and combinations thereof. Non-limiting examples of specific triglycerides include triglycerides such as, for example, tristearin, tripalmitin, 1,2-dipalmitoolein, 1,3-dipalmitoolein, 1-palmito-3-stearo-2-olein, 1-palmito-2-stearo-3-olein, 2-palmito-1-stearo-3-olein, 1,2-dipalmitolinolein, 1,2-distearo-olein, 1,3-distearo-olein, trimyristin, trilaurin and combinations thereof. Non-limiting examples of specific fatty acids contemplated include lauric acid, myristic acid, palmitic acid, stearic acid, and mixtures thereof. Other specific waxes contemplated include hydrogenated soy bean oil, partially hydrogenated soy bean oil, partially hydrogenated palm kernel oil, and combinations thereof. Inedible waxes from Jatropha and rapeseed oil can also be used. The wax can be selected from the group consisting of a hydrogenated plant oil, a partially hydrogenated plant oil, an epoxidized plant oil, a maleated plant oil, and combinations thereof.

Specific examples of such plant oils include soy bean oil, corn oil, canola oil, and palm kernel oil.

The soap can alternatively comprise fossil-based materials. Specific examples of fossil-based (e.g., mineral) materials include paraffin (including petrolatum), Montan wax, as well as polyolefin waxes produced from cracking processes, such as polyethylene derived waxes.

Fossil-based (e.g., mineral) waxes and/or oils can be combined with bio-derived renewable materials in any desired proportion. For example, the soap can comprise greater than 10%, or greater than 50%, or from 30-100%, or from 1-100% renewable material. (i.e., renewable biobased materials), based upon the total weight of soap present. Bio-based materials can be differentiated by their carbon-14 content. The level of renewable materials present in an a composition can be determined using ASTM test method D6866, as previously discussed herein.

Soaps can be water dispersible or water insoluble. Water dispersible herein means disassociating to form a micellar structure when placed in water or other polar solvent. The test for water dispersible is the same for measuring the amount percent soap described above, except the solvent used is water. If more than 5 weight percent of the soap and less than 50 weight percent is removed in the test, then the soap is water dispersible. Water soluble soaps include sodium and potassium stearate and other metal ions from group 1 metals of the periodic table of the elements using the IUPAC naming system implemented in 1988. Water insoluble soaps include metal ions from group 2, 3, 4, 5, 6, 7, 8, 9, 10, 11, 12, 13, 14, 15, 16 of the periodic table of the elements using the IUPAC naming system implemented in 1988; examples include magnesium stearate, calcium stearate, and zinc stearate. If 50 weight percent or more of the soap is removed in the water test, then the soap is water soluble.

### Additives

The compositions disclosed herein can further include an additive. The additive can be dispersed throughout the composition, or can be substantially in the thermoplastic polymer portion of the thermoplastic layer or substantially in the soap portion of the composition. In cases where the additive is in the soap portion of the composition, the additive is desirably soap soluble or soap dispersible.

Non-limiting examples of classes of additives contemplated in the compositions disclosed herein include perfumes, dyes, pigments, nanoparticles, antistatic agents, fillers, and combinations thereof. The compositions disclosed herein can contain a single additive or a mixture of additives. For example, both a perfume and a colorant (e.g., pigment and/or dye) can be present in the composition. The additive(s), when present, is/are typically present in a weight percent of 0.05 wt % to 20 wt %, or 0.1 wt % to 10 wt %, based upon the total weight of the composition.

As used herein the term “perfume” is used to indicate any odoriferous material that is subsequently released from the composition as disclosed herein. A wide variety of chemicals are known for perfume uses, including materials such as aldehydes, ketones, alcohols, and esters. More commonly, naturally occurring plant and animal oils and exudates including complex mixtures of various chemical components are known for use as perfumes. The perfumes herein can be relatively simple in their compositions or can include highly sophisticated complex mixtures of natural and/or synthetic chemical components, all chosen to provide any desired odor. Typical perfumes can include, for example, woody/earthy bases containing exotic materials, such as sandalwood, civet and patchouli oil. The perfumes can be of a light floral fragrance (e.g. rose extract, violet extract, and lilac). The perfumes can also be formulated to provide desirable fruity odors, e.g. lime, lemon, and orange. The perfumes delivered in the compositions and articles of the present invention can be selected for an aromatherapy effect, such as providing a relaxing or invigorating mood. As such, any material that exudes a pleasant or otherwise desirable odor can be used as a perfume active in the compositions and articles of the present invention.

A pigment or dye can be inorganic, organic, or a combination thereof. Specific examples of pigments and dyes contemplated include pigment Yellow (C.I. 14), pigment Red (C.I. 48:3), pigment Blue (C.I. 15:4), pigment Black (C.I. 7), and combinations thereof. Specific contemplated dyes include water soluble ink colorants like direct dyes, acid dyes, base dyes, and various solvent soluble dyes. Examples include, but are not limited to, FD&C Blue 1 (C.I. 42090:2), D&C Red 6(C.I. 15850), D&C Red 7(C.I. 15850:1), D&C Red 9(C.I. 15585:1), D&C Red 21(C.I. 45380:2), D&C Red 22(C.I. 45380:3), D&C Red 27(C.I. 45410:1), D&C Red 28(C.I. 45410:2), D&C Red 30(C.I. 73360), D&C Red 33(C.I. 17200), D&C Red 34(C.I. 15880:1), and FD&C Yellow 5(C.I. 19140:1), FD&C Yellow 6(C.I. 15985:1), FD&C Yellow 10(C.I. 47005:1), D&C Orange 5(C.I. 45370:2), and combinations thereof.

Contemplated fillers include, but are not limited to, inorganic fillers such as, for example, the oxides of magnesium, aluminum, silicon, and titanium. These materials can be added as inexpensive fillers or processing aides. Other inorganic materials that can function as fillers include hydrous magnesium silicate, titanium dioxide, calcium carbonate, clay, chalk, boron nitride, limestone, diatomaceous earth, mica glass quartz, and ceramics. Additionally, inorganic salts, including alkali metal salts, alkaline earth metal salts, phosphate salts, can be used. Additionally, alkyd resins can also be added to the composition. Alkyd resins can comprise a polyol, a polyacid or anhydride, and/or a fatty acid.

Additional contemplated additives include nucleating and clarifying agents for the thermoplastic polymer. Specific examples, suitable for polypropylene, for example, are benzoic acid and derivatives (e.g., sodium benzoate and lithium benzoate), as well as kaolin, talc and zinc glycerolate. Dibenzlidene sorbitol (DBS) is an example of a clarifying agent that can be used. Other nucleating agents that can be used are organocarboxylic acid salts, sodium phosphate and metal salts (e.g., aluminum dibenzoate). In one aspect, the nucleating or clarifying agents can be added in the range from 20 parts per million (20 ppm) to 20,000 ppm, or from 200 ppm to 2000 ppm, or from 1000 ppm to 1500 ppm. The addition of the nucleating agent can be used to improve the tensile and impact properties of the finished polymer-soap composition.

Contemplated surfactants include anionic surfactants, amphoteric surfactants, or a combination of anionic and amphoteric surfactants, and combinations thereof, such as surfactants disclosed, for example, in U.S. Pat. Nos. 3,929,678 and 4,259,217 and in EP 414 549, WO93/08876 and WO93/08874.

Contemplated nanoparticles include metals, metal oxides, allotropes of carbon, clays, organically modified clays, sulfates, nitrides, hydroxides, oxy/hydroxides, particulate water-insoluble polymers, silicates, phosphates and carbonates. Examples include silicon dioxide, carbon black, graphite, grapheme, fullerenes, expanded graphite, carbon nanotubes, talc, calcium carbonate, betonite, montmorillonite, kaolin, zinc glycerolate, silica, aluminosilicates, boron nitride, aluminum nitride, barium sulfate, calcium sulfate, antimony oxide, feldspar, mica, nickel, copper, iron, cobalt, steel, gold, silver, platinum, aluminum, wollastonite, aluminum oxide, zirconium oxide, titanium dioxide, cerium oxide, zinc oxide, magnesium oxide, tin oxide, iron oxides (Fe₂O₃, Fe₃O₄) and mixtures thereof. Nanoparticles can increase strength, thermal stability, and/or abrasion resistance of the compositions disclosed herein, and can give the compositions electric properties.

It is contemplated to add oils or that some amount of oil is present in the composition. The amount of oil present can range from 0 weight percent to 40 weight percent, or from 5 weight percent to 20 weight percent, or from 8 weight percent to 15 weight percent, by weight of the total composition.

Contemplated anti-static agents include fabric softeners that are known to provide antistatic benefits. This can include those fabric softeners having a fatty acyl group that has an iodine value of greater than 20, such as N,N-di(tallowoyl-oxy-ethyl)-N,N-dimethyl ammonium methylsulfate.

### Processes of Making the Compositions as Disclosed Herein

Melt Mixing of the Polymer and Soap:

The polymer and soap can be suitably mixed by melting the polymer in the presence of the soap. In the melt state, the polymer and soap are subjected to shear which enables a dispersion of the soap into the polymer. The soap does not have to be molten when added to the thermoplastic polymer. For example, the soap can be melted in the presence of the thermoplastic polymer to prepare the intimate admixture. Alternatively, the molten soap can be added to molten thermoplastic polymer. In the melt state, the soap and polymer are significantly more compatible with each other.

The melt mixing of the polymer and soap can be accomplished by a number of different processes. The processes can involve traditional thermoplastic polymer processing equipment. For example, a process with high shear can be used to generate the intimate admixture. The general process order involves adding the polymer to the system, melting the polymer, and then adding the soap. However, the materials can be added in any order, depending on the nature of the specific mixing system.

Haake Batch Mixer:

A Haake Batch mixer is a simple mixing system with a low amount of shear and mixing. The unit is composed of two mixing screws contained within a heated fixed volume chamber. The materials are added into the top of the unit as desired. The preferred order is to add the polymer into the chamber first and heat to 20° C. to 120° C. above the polymer's melting (or solidification) temperature. Once the polymer is melted, the soap can be added, melted, and mixed with the molten polymer. The mixture is then further mixed in the melt with the two mixing screws for 5 to 15 minutes at screw RPM from 60 to 120. Once the composition is mixed, the front of the unit is removed and the mixed composition is removed in the molten state. By its design, this system leaves parts of the composition at elevated temperatures before crystallization starts for several minutes. This mixing process provides an intermediate quenching process, where the composition can take 30 seconds to 2 minutes to cool down and solidify. When mixing polypropylene with magnesium stearate in the Haake mixture, addition of greater than 20 wt % of molten soap leads to incomplete incorporation of the soap in the polypropylene mixture as evidenced by soap droplet size. Higher shear rates can lead to better dispersion of soap and thus facilitate the incorporation of greater amounts of soap.

Single Screw Extruder:

A single screw extruder is a typical process unit used in most molten polymer extrusion. The single screw extruder typically includes a single shaft within a barrel, the shaft and barrel engineered with certain screw elements (e.g., shapes and clearances) to adjust the shearing profile. A typical RPM range for single screw extruders is 10 to 120. The single screw extruder design is composed of a feed section, compression section, and metering section. In the feed section, using fairly high void volume flights, the polymer is heated and supplied into the compression section, where the melting is completed and the fully molten polymer is sheared. In the compression section, the void volume between the flights is reduced. In the metering section, the polymer is subjected to its highest shearing amount using low void volume between flights. General purpose single screw designs can be used. In this unit, a continuous or steady state type of process is achieved where the composition components are introduced at desired locations, and then subjected to temperatures and shear within target zones. The process can be considered to be a steady state process as the physical nature of the interaction at each location in the single screw process is constant as a function of time. This allows for optimization of the mixing process by enabling a zone-by-zone adjustment of the temperature and shear, where the shear can be changed through the screw elements and/or barrel design or screw speed.

The mixed composition exiting the single screw extruder can then be pelletized via extrusion of the melt into a liquid cooling medium, for example water, and then the polymer strand can be cut into small pieces or pellets. Alternatively, the mixed composition can be used to produce the final formed structure, for example fibers. There are two basic types of molten polymer pelletization process used in polymer processing: strand cutting and underwater pelletization. In strand cutting the composition is rapidly quenched (generally in much less than 10 seconds) in the liquid medium, then cut into small pieces. In the underwater pelletization process, the molten polymer is cut into small pieces then simultaneously or immediately thereafter placed in the presence of a low temperature liquid that rapidly quenches and crystallizes the polymer. These methods are commonly known and used within the polymer processing industry.

The polymer strands that come from the extruder are rapidly placed into a water bath, most often having a temperature range of 1° C. to 50° C. (e.g., normally at room temperature, which is 25° C.). An alternate end use for the mixed composition is further processing into the desired structure, for example fiber spinning and film or injection molding. The single screw extrusion process can provide for a high level of mixing and high quench rate. A single screw extruder also can be used to further process a pelletized composition into fibers and injection molded articles. For example, the fiber single screw extruder can be a 37 mm system with a standard general purpose screw profile and a 30:1 length to diameter ratio.

Twin Screw Extruder:

A twin screw extruder is the typical unit used in most molten polymer extrusion where high intensity mixing is required. The twin screw extruder includes two shafts and an outer barrel. A typical RPM range for twin screw extruders is 10 to 1200. The two shafts can be co-rotating or counter rotating and allow for close tolerance, high intensity mixing. In this type of unit, a continuous or steady state type of process is achieved where the composition components are introduced at desired locations along the screws, and subjected to high temperatures and shear within target zones. The process can be considered to be a steady state process as the physical nature of the interaction at each location in the twin screw process is constant as a function of time. This allows for optimization of the mixing process by enabling a zone-by-zone adjustment of the temperature and shear, where the shear can be changed through the screw elements and/or barrel design.

The mixed composition at the end of the twin screw extruder can then be pelletized via extrusion of the melt into a liquid cooling medium, often water, and then the polymer strand is cut into small pieces or pellets. Alternatively, the mixed composition can be used to produce the final formed structure, for example fibers. There are two basic types of molten polymer pelletization processes used in polymer processing, namely strand cutting and underwater pelletization. In strand cutting the composition is rapidly quenched (generally in much less than 10 s) in the liquid medium then cut into small pieces. In the underwater pelletization process, the molten polymer is cut into small pieces then simultaneously or immediately thereafter placed in the presence of a low temperature liquid that rapidly quenches and crystallizes the polymer. An alternate end use for the mixed composition is direct further processing into filaments or fibers via spinning of the molten admixture accompanied by cooling.

One screw profile can be employed using a Baker Perkins CT-25 25 mm corotating 52:1 length to diameter ratio system. This specific CT-25 is composed of 11 zones where the temperature can be controlled, as well as the die temperature. Four liquid injection sites are also possible, located between zone 1 and 2 (location A), zone 2 and 3 (location B), zone 5 and 6 (location C). and zone 7 and 8 (location D).

The liquid injection location is not heated directly, but rather indirectly through the adjacent heated zone. Locations A, B, C, and D can be used to inject the soap, or the soap can be added in the beginning along with the thermoplastic polymer. A side feeder for adding additional solids or a vent can be included between Zone 6 and Zone 7. Zone 10 contains a vacuum for removing any residual vapor, as needed. Unless noted otherwise, the soap is added in Zone 1. Alternatively, the soap is melted via a glue tank and supplied to the twin-screw via a heated hose. Both the glue tank and the supply hose are heated at a temperature greater than the melting point of the soap (e.g., 170° C.).

Two types of regions, conveyance and mixing, are used in the CT-25. In the conveyance region, the materials are heated (including thorough melting in Zone 1 into Zone 2 if needed) and conveyed along the length of the barrel, under low to moderate shear. The mixing section contains special elements that dramatically increase shear and mixing. The length and location of the mixing sections can be changed as needed to increase or decrease shear as needed.

The standard mixing screw for the CT-25 is composed of two mixing sections. The first mixing section is located in zone 3 to 5 and is one RKB 45/5/36 then two RKB45/5/24 followed by two RKB 45/5/12, a reversing RKB 45/5/12 LH (left handed), then 10 RKB 45/5/12 and then a reversing element RSE 24/12 LH followed by conveyance into the second mixing section using five RSE36/36 elements. Prior to the second mixing section is one RSE 24/24 and two RSE 16/16 (right handed conveyance element with 16 mm pitch and 16 mm total element length) elements are used to increase pumping into the second mixing region. The second mixing region, located in zone 7 and zone 8, is one RKB 45/5/36 then two RKB45/5/24 followed by six RKB 45/5/12 and then a full reversing element SE 24/12 LH. The combination of the SE 16/16 elements in front of the mixing zone and single reversing elements greatly increases the shear and mixing. The remaining screw elements are conveyance elements.

An additional screw element type is a reversing element, which can increase the filling level in that part of the screw and provide better mixing. Twin screw compounding is a mature field. One skilled in the art can consult books for proper mixing and dispersion. These types of screw extruders are well understood in the art and a general description can be found in: Twin Screw Extrusion 2E: Technology and Principles by James White from Hansen Publications. Although specific examples are given for mixing, many different combinations are possible using various element configurations to achieve the needed level of mixing to form the intimate admixtures.

A second compounding system can be used to prepare the mixed composition. A second screw profile can be employed using a Warner & Pfleiderer 30 mm (WP-30) corotating 48:1 length to diameter ratio system. This specific WP-30 is composed of 12 zones where the temperature can be controlled, as well as the die temperature. Materials are fed into the extruder in Zone 1. A vent is located in Zone 11.

The exact nature of the extruder and screw design are not as critical so long as the composition can be mixed, for example, at a shear rate greater than 10 s⁻¹, or greater than 30 s⁻¹, or from 10 to 10,000 s⁻¹, or from 30 to 10,000 s⁻¹ depending on the forming method (e.g. fiber spinning, film casting/blowing, injection molding, or bottle blowing), to form the intimate admixture The higher the shear rate of the mixing, the greater the dispersion in the composition as disclosed herein. Thus, the dispersion can be controlled by selecting a particular shear rate during formation of the composition.

### Articles of Manufacture

The composition of the present invention can be used to make articles in a variety of forms, including fibers, films, and molded objects. As used herein, “article” refers to the composition in its hardened state at or near 25° C. The articles can be used in their present form (e.g., a bottle, an automotive part, a component of an absorbent hygiene product), or can be used for subsequent re-melt and/or manufacture into other articles (e.g., pellets, fibers). Manufacturing processes for making various article forms of the present invention are set forth herein.

Fibers

The fibers in the present invention may be monocomponent or multicomponent. The term “fiber” is defined as a solidified polymer shape with a length to thickness ratio of greater than 50, greater than 500 and greater than 1,000. The monocomponent fibers of the present invention may also be multiconstituent. Constituent, as used herein, is defined as meaning the chemical species of matter or the material. Multiconstituent fiber, as used herein, is defined to mean a fiber containing more than one chemical species or material. Multiconstituent and alloyed polymers have the same meaning in the present invention and can be used interchangeably. Generally, fibers may be of monocomponent or multicomponent types. Component, as used herein, is defined as a separate part of the fiber that has a spatial relationship to another part of the fiber. The term multicomponent, as used herein, is defined as a fiber having more than one separate part in spatial relationship to one another. The term multicomponent includes bicomponent, which is defined as a fiber having two separate parts in a spatial relationship to one another. The different components of multicomponent fibers are arranged in substantially distinct regions across the cross-section of the fiber and extend continuously along the length of the fiber. Methods for making multicomponent fibers are well known in the art. Multicomponent fiber extrusion was well known in the 1960's. DuPont was a lead technology developer of multicomponent capability, with U.S. Pat. No. 3,244,785 and U.S. Pat. No. 3,704,971 providing a description of the technology used to make these fibers. “Bicomponent Fibers” by R. Jeffries from Merrow Publishing in 1971 laid a solid groundwork for bicomponent technology. More recent publications include “Taylor-Made Polypropylene and Bicomponent Fibers for the Nonwoven Industry,” Tappi Journal December 1991 (p. 103) and “Advanced Fiber Spinning Technology” edited by Nakajima from Woodhead Publishing.

The nonwoven fabric formed in the present invention may contain multiple types of monocomponent fibers that are delivered from different extrusion systems through the same spinneret. The extrusion system, in this example, is a multicomponent extrusion system that delivers different polymers to separate capillaries. For instance, one extrusion system delivers a composition as described herein and the other a polypropylene copolymer such that the copolymer composition melts at different temperatures. In another instance, one extrusion system might deliver a polyethylene resin and the other a composition as described herein. In a third instance, one extrusion system might deliver a first composition as described herein and the second a composition as described herein that have different thermoplastic polymers. The polymer ratios in this system can range from 95:5 to 5:95, or from 90:10 to 10:90, or from 80:20 to 20:80.

Bicomponent and multicomponent fibers may be in a side-by-side, sheath-core (symmetric and eccentric), segmented pie, ribbon, islands-in-the-sea configuration, or any combination thereof. The sheath may be continuous or non-continuous around the core. Exemplary multicomponent fibers are disclosed in U.S. Pat. No. 6,746,766. The ratio of the weight of the sheath to the core is from 5:95 to 95:5. The fibers of the present invention may have different geometries that include, but are not limited to, round, elliptical, star shaped, trilobal, multilobal with 3-8 lobes, rectangular, H-shaped, C-shaped, 1-shape, U-shaped, or any other suitable shape. Hollow fibers can also be used. In many instances the shapes are round, trilobal or H-shaped. The round and trilobal fiber shapes can also be hollow.

Often utilized are sheath and core bicomponent fibers. In one instance, the component in the core contains a composition as described herein, while the sheath does not. In this instance the exposure to a composition as described herein at the surface of the fiber is reduced or eliminated. In another instance, the sheath may contain a composition as described herein but the core does not. In this case, the concentration of a composition as described herein at the fiber surface is higher than in the core. Using sheath and core bicomponent fibers, the concentration of a composition as described herein can be selected to impart desired properties either in the sheath or core, or some concentration gradient. It should be understood that islands-in-the-sea bicomponent fibers are considered to be a type of sheath and core fiber, but with multiple cores. Segmented pie fibers (hollow and solid) are contemplated. They can be used, for example, to split regions that contain wax from regions that do not contain wax, using segmented pie type of bicomponent fiber design. Splitting may occur during mechanical deformation, application of hydrodynamic forces, or other suitable processes.

Tricomponent fibers are also contemplated. One example of a useful tricomponent fiber is a three layered sheath/sheath/core fiber, where each component contains a different blend of the composition as described herein. Different amounts of a composition as described herein in each layer may provide additional benefits. For example, the core can be a blend of 10 melt flow polypropylene with a composition as described herein. The middle layer sheath may be a blend of 25 melt flow polypropylene with a composition as described herein and the outer layer may be straight 35 melt flow rate polypropylene. An exemplary composition as described herein has a content in each layer of less than 40 wt %, or less than 20 wt %. Another type of useful tricomponent fiber contemplated is a segmented pie type bicomponent design that also has a sheath.

A “highly attenuated fiber” is defined as a fiber having a high draw down ratio. The total fiber draw down ratio is defined as the ratio of the fiber at its maximum diameter (which typically results immediately after exiting the capillary) to the final fiber diameter in its end use. The total fiber draw down ratio will be greater than 1.5, or greater than 5, or greater than 10, or greater than 12. This is necessary to achieve the tactile properties and useful mechanical properties.

The fiber will have a diameter of less than 200 μm. The fiber diameter can be as low as 0.1 μm if the mixture is being used to produce fine fibers. The fibers can be either essentially continuous or essentially discontinuous. Fibers commonly used to make spunbond nonwovens will have a diameter of from 5 μm to 30 μm, or from 10 μm to 20 μm, or from 12 μm to 18 μm. Fine fiber diameter will have a diameter from 0.1 μm to 5 μm, or from 0.2 μm to 3 μm and most preferred from 0.3 μm to 2 μm Fiber diameter is controlled by die geometry, spinning speed or drawing speed, mass through-put, and blend composition and rheology. The fibers as described herein can be environmentally degradable.

The fibers described herein are typically used to make disposable nonwoven articles. The articles can be flushable. The term “flushable” as used herein refers to materials which are capable of dissolving, dispersing, disintegrating, and/or decomposing in a septic disposal system such as a toilet to provide clearance when flushed down the toilet without clogging the toilet or any other sewage drainage pipe. The fibers and resulting articles may also be aqueous responsive. The term aqueous responsive as used herein means that when placed in water or flushed, an observable and measurable change will result. Typical observations include noting that the article swells, pulls apart, dissolves, or observing a general weakened structure.

The hydrophilicity and hydrophobicity of the fibers can be adjusted in the present invention. The base resin properties can have hydrophilic properties via copolymerization (such as the case for certain polyesters (EASTONE from Eastman Chemical, the sulfopolyester family of polymers in general) or polyolefins such as polypropylene or polyethylene) or have materials added to the base resin to render it hydrophilic. Exemplarily examples of additives include CIBA Irgasurf® family of additives. The fibers in the present invention can also be treated or coated after they are made to render them hydrophilic. In the present invention, durable hydrophilicity is preferred. Durable hydrophilicity is defined as maintaining hydrophilic characteristics after more than one fluid interaction. For example, if the sample being evaluated is tested for durable hydrophilicity, water can be poured on the sample and wetting observed. If the sample wets out it is initially hydrophilic. The sample is then completely rinsed with water and dried. The rinsing is best done by putting the sample in a large container and agitating for ten seconds and then drying. The sample after drying should also wet out when contacted again with water.

After the fiber is formed, the fiber may further be treated or the bonded fabric can be treated. A hydrophilic or hydrophobic finish can be added to adjust the surface energy and chemical nature of the fabric. For example, fibers that are hydrophobic may be treated with wetting agents to facilitate absorption of aqueous liquids. A bonded fabric can also be treated with a topical solution containing surfactants, pigments, slip agents, salt, or other materials to further adjust the surface properties of the fiber.

The fibers in the present invention can be crimped, although it is preferred that they are not crimped. Crimped fibers are generally produced in two methods. The first method is mechanical deformation of the fiber after it is already spun. Fibers are melt spun, drawn down to the final filament diameter and mechanically treated, generally through gears or a stuffer box that imparts either a two dimensional or three dimensional crimp. This method is used in producing most carded staple fibers. The second method for crimping fibers is to extrude multicomponent fibers that are capable of crimping in a spunlaid process. One of ordinary skill in the art would recognize that a number of methods of making bicomponent crimped spunbond fibers exists; however, for the present invention, three main techniques are considered for making crimped spunlaid nonwovens. The first is crimping that occurs in the spinline due to differential polymer crystallization in the spinline, a result of differences in polymer type, polymer molecular weight characteristics (e.g., molecular weight distribution) or additives content. A second method is differential shrinkage of the fibers after they have been spun into a spunlaid substrate. For instance, heating the spunlaid web can cause fibers to shrink due to differences in crystallinity in the as-spun fibers, for example during the thermal bonding process. A third method of causing crimping is to mechanically stretch the fibers or spunlaid web (generally for mechanical stretching the web has been bonded together). The mechanical stretching can expose differences in the stress-strain curve between the two polymer components, which can cause crimping.

The tensile strength of a fiber is approximately greater than 25 Mega Pascal (MPa). The fibers as disclosed herein have a tensile strength of greater than 50 MPa, or greater than 75 MPa, or greater than 100 MPa. Tensile strength is measured using an Instron following a procedure described by ASTM standard D 3822-91 or an equivalent test.

The fibers as disclosed herein are not brittle and have a toughness of greater than 2 MPa, greater than 50 MPa, or greater than 100 MPa. Toughness is defined as the area under the stress-strain curve where the specimen gauge length is 25 mm with a strain rate of 50 mm per minute. Elasticity or extensibility of the fibers may also be desired.

The fibers as disclosed herein can be thermally bondable if sufficient thermoplastic polymers are present in the fiber or on the outside component of the fiber (i.e. sheath of a bicomponent). Thermally bondable fibers are best used in the pressurized heat and thru-air heat bonding methods. Thermally bondable is typically achieved when the composition is present at a level of greater than 15%, or greater than 30%, or greater than 40%, or greater than 50% by weight of the fiber.

The fibers disclosed herein can be environmentally degradable depending upon the amount of the composition that is present and the specific configuration of the fiber. “Environmentally degradable” is defined as being biodegradable, disintigratable, dispersible, flushable, or compostable or a combination thereof. The fibers, nonwoven webs, and articles can be environmentally degradable. As a result, the fibers may be easily and safely disposed of either in existing composting facilities or may be flushable and can be safely flushed down the drain without detrimental consequences to existing sewage infrastructure systems. The flushability of the fibers when used in disposable products such as wipes and feminine hygiene items offer additional convenience and discretion to the consumer.

The term “biodegradable” refers to matter that, when exposed to an aerobic and/or anaerobic environment, is eventually reduced to monomeric components due to microbial, hydrolytic, and/or chemical actions. Under aerobic conditions, biodegradation leads to the transformation of the material into end products such as carbon dioxide and water. Under anaerobic conditions, biodegradation leads to the transformation of the materials into carbon dioxide, water, and methane. The biodegradability process is often described as mineralization. Biodegradability means that all organic constituents of the matter (e.g., fibers) are subject to decomposition eventually through biological activity.

There are a variety of different standardized biodegradability methods that have been established over time by various organizations and in different countries. Although the tests vary in the specific testing conditions, assessment methods, and criteria desired, there is reasonable convergence between different protocols so that they are likely to lead to similar conclusions for most materials. For aerobic biodegrability, the American Society for Testing and Materials (ASTM) has established ASTM D 5338-92: Test methods for Determining Aerobic Biodegradation of Plastic Materials under Controlled Composting Conditions. The ASTM test measures the percent of test material that mineralizes as a function of time by monitoring the amount of carbon dioxide being released as a result of assimilation by microorganisms in the presence of active compost held at a thermophilic temperature of 58° C. Carbon dioxide production testing may be conducted via electrolytic respirometry. Other standard protocols, such 301B from the Organization for Economic Cooperation and Development (OECD), may also be used. Standard biodegradation tests in the absence of oxygen are described in various protocols such as ASTM D 5511-94. These tests are used to simulate the biodegradability of materials in an anaerobic solid-waste treatment facility or sanitary landfill. However, these conditions are less relevant for the type of disposable applications that are described for the fibers and nonwovens as described herein.

Disintegration occurs when the fibrous substrate has the ability to rapidly fragment and break down into fractions small enough not to be distinguishable after screening when composted or to cause drainpipe clogging when flushed. A disintegratable material will also be flushable. Most protocols for disintegradability measure the weight loss of test materials over time when exposed to various matrices. Both aerobic and anaerobic disintegration tests are used. Weight loss is determined by the amount of fibrous test material that is no longer collected on an 18 mesh sieve with 1 millimeter openings after the materials is exposed to wastewater and sludge. For disintegration, the difference in the weight of the initial sample and the dried weight of the sample recovered on a screen will determine the rate and extent of disintegration. The testing for biodegradability and disintegration are very similar as a very similar environment, or the same environment, will be used for testing. To determine disintegration, the weight of the material remaining is measured while for biodegradability, the evolved gases are measured. The fibers disclosed herein can rapidly disintegrate.

The fibers as disclosed herein can also be compostable. ASTM has developed test methods and specifications for compostability. The test measures three characteristics: biodegradability, disintegration, and lack of ecotoxicity. Tests to measure biodegradability and disintegration are described above. To meet the biodegradability criteria for compostability, the material must achieve at least 60% conversion to carbon dioxide within 40 days. For the disintegration criteria, the material must have less than 10% of the test material remain on a 2 millimeter screen in the actual shape and thickness that it would have in the disposed product. To determine the last criteria, lack of ecotoxicity, the biodegradation byproducts must not exhibit a negative impact on seed germination and plant growth. One test for this criteria is detailed in OECD 208. The International Biodegradable Products Institute will issue a logo for compostability once a product is verified to meet ASTM 6400-99 specifications. The protocol follows Germany's DIN 54900 which determine the maximum thickness of any material that allows complete decomposition within one composting cycle.

The fibers described herein can be used to make disposable nonwoven articles. The articles are commonly flushable. The term “flushable” as used herein refers to materials which are capable of dissolving, dispersing, disintegrating, and/or decomposing in a septic disposal system such as a toilet to provide clearance when flushed down the toilet without clogging the toilet or any other sewage drainage pipe. The fibers and resulting articles may also be aqueous responsive. The term aqueous responsive as used herein means that when placed in water or flushed, an observable and measurable change will result. Typical observations include noting that the article swells, pulls apart, dissolves, or observing a general weakened structure.

The nonwoven products produced from the fibers exhibit certain mechanical properties, particularly, strength, flexibility, softness, and absorbency. Measures of strength include dry and/or wet tensile strength. Flexibility is related to stiffness and can attribute to softness. Softness is generally described as a physiologically perceived attribute which is related to both flexibility and texture. Absorbency relates to the products' ability to take up fluids as well as the capacity to retain them.

Processes for Making Fibers

Fibers can be spun from a melt of the compositions as disclosed herein. In melt spinning, there is no mass loss in the extrudate. Melt spinning is differentiated from other spinning, such as wet or dry spinning from solution, where a solvent is being eliminated by volatilizing or diffusing out of the extrudate resulting in a mass loss.

Spinning can occur at 120° C. to 320° C., or 185° C. to 250° C., or from 200° C. to 230° C. Fiber spinning speeds of greater than 100 meters/minute are preferred. An exemplary fiber spinning speed is 1,000 to 10,000 meters/minute, or 2,000 to 7,000 meters/minute, or 2,500 to 5,000 meters/minute. The polymer composition is spun fast to avoid brittleness in the fiber.

Continuous filaments or fibers can be produced through spunbond methods. Essentially continuous or essentially discontinuous filaments or fibers can be produced through melt fibrillation methods such as meltblowing or melt film fibrillation processes. Alternatively, non-continuous (staple fibers) fibers can be produced. The various methods of fiber manufacturing can also be combined to produce a combination technique.

The homogeneous blend can be melt spun into monocomponent or multicomponent fibers on conventional melt spinning equipment. The equipment will be chosen based on the desired configuration of the multicomponent. Commercially available melt spinning equipment is available from Hills, Inc. located in Melbourne, Fla. The temperature for spinning is 100° C. to 320° C. The processing temperature is determined by the chemical nature, molecular weights and concentration of each component. The fibers spun can be collected using conventional godet winding systems or through air drag attenuation devices. If the godet system is used, the fibers can be further oriented through post extrusion drawing at temperatures of 25° C. to 200° C. The drawn fibers may then be crimped and/or cut to form non-continuous fibers (staple fibers) used in a carding, airlaid, or fluidlaid process.

For example, a suitable process for spinning bicomponent sheath core fibers using the disclosed composition in the sheath and a different composition in the core is as follows. A composition is first prepared through compounding containing 10 wt % HCO and a second composition is first prepared through compounding containing 30 wt % HCO. The 10 wt % HCO component extruder profile may be 180° C., 200° C. and 220° C. in the first three zones of a three heater zone extruder. The transfer lines and melt pump heater temperatures may be 220° C. for the first composition. The second composition extruder temperature profile can be 180° C., 230° C. and 230° C. in the first three zones of a three heater zone extruder. The transfer lines and melt pump can be heated to 230° C. In this case, the spinneret temperature can be 220° C. to 230° C.

Fine Fiber Production

The homogenous blend is spun, for example, into one or more filaments or fibers by melt film fibrillation. Suitable systems and melt film fibrillation methods are described in U.S. Pat. Nos. 6,315,806, 5,183,670, and 4,536,361, to Torobin et al., and U.S. Pat. Nos. 6,382,526, 6,520,425, and 6,695,992, to Reneker et al. and assigned to the University of Akron. Other melt film fibrillation methods and systems are described in the U.S. Pat. Nos. 7,666,343 and 7,931,457, to Johnson, et al., U.S. Pat. No. 7,628,941, to Krause et al., and U.S. Pat. No. 7,722,347, to Krause, et al. Methods and apparatus described in the above patents provide nonwoven webs with uniform and narrow fiber distribution, reduced or minimal fiber defects. Melt film fibrillation process comprises providing one or more melt films of the homogenous blend, one or more pressurized fluid streams (or fiberizing fluid streams) to fibrillate the melt film into ligaments, which are attenuated by the pressurized fluid stream. Optionally, one or more pressurized fluid streams may be provided to aid the attenuation and quenching of the ligaments to form fibers. Fibers produced from the melt film fibrillation process using one homogenous blend would have diameters typically ranging from 100 nanometer (0.1 micrometer) to 5000 nanometer (5 micrometer). In some instances, the fibers produced from the melt film fibrillation process of the homogenous blend would be less than 2 micrometer, or less than 1 micrometer (1000 nanometer), or in the range of 100 nanometer (0.1 micrometer) to 900 nanometer (0.9 micrometer). The average diameter (an arithmetic average diameter of at least 100 fiber samples) of fibers of the homogenous blend produced using the melt film fibrillation would be less than 2.5 micrometer, or less than 1 micrometer, or less than 0.7 micrometer (700 nanometer). The median fiber diameter can be 1 micrometer or less. In some instances, at least 50% of the fibers of the homogenous blend produced by the melt film fibrillation process may have a diameter less than 1 micrometer, or at least 70% of the fibers may have a diameter less than 1 micrometer, or at least 90% of the fibers may have a diameter less than 1 micrometer. In certain instances, even 99% or more fibers may have a diameter less than 1 micrometer when produced using the melt film fibrillation process.

In the melt film fibrillation process, the homogenous blend is typically heated until it forms a liquid and flows easily. The homogenous blend may be at a temperature of from 120° C. to 350° C. at the time of melt film fibrillation, or from 160° C. to 350° C., or from 200° C. to 300° C. The temperature of the homogenous blend depends on the composition. The heated homogenous blend is at a pressure from 15 pounds per square inch absolute (psia) to 400 psia, or from 20 psia to 200 psia, or from 25 psia to 100 psia.

Non-limiting examples of the pressurized fiberizing fluid stream are gases such as air or nitrogen or any other fluid compatible (defined as reactive or inert) with homogenous blend composition. The fiberizing fluid stream can be at a temperature close to the temperature of the heated homogenous blend. The fiberizing fluid stream temperature may be at a higher temperature than the heated homogenous blend to help in the flow of the homogenous blend and the formation of the melt film. In some instances, the fiberizing fluid stream temperature is 100° C. above the heated homogenous blend, or 50° C. above the heated homogenous blend, or just at the temperature of the heated homogenous blend. Alternatively, the fiberizing fluid stream temperature can be below the heated homogenous blend temperature. In some instances, the fiberizing fluid stream temperature is 50° C. below the heated homogenous blend, or 100° C. below the heated homogenous blend, or 200° C. below the heated homogenous blend. In certain instances, the temperature of the fiberizing fluid stream may be ranging from −100° C. to 450° C., or −50° C. to 350° C., or 0° C. to 300° C. The pressure of the fiberizing fluid stream is sufficient to fibrillate the homogenous blend into fibers, and is above the pressure of the heated homogenous blend. The pressure of the fiberizing fluid stream may range from 15 psia to 500 psia, or from 30 psia to 200 psia, or from 40 psia to 100 psia. The fiberizing fluid stream may have a velocity of more than 200 meter per second at the location of melt film fibrillation. In some instances, at the location of melt film fibrillation, the fiberizing fluid stream velocity will be more than 300 meter per second, i.e., transonic velocity; in other instances more than 330 meter per second, i.e., sonic velocity; and in yet other instances from 350 to 900 meters per second (m/s), i.e., supersonic velocity from Mach 1 to Mach 3. The fiberizing fluid stream may pulsate or may be a steady flow. The homogenous blend throughput will primarily depend upon the specific homogenous blend used, the apparatus design, and the temperature and pressure of the homogenous blend. The homogenous blend throughput will be more than 1 gram per minute per orifice, for example in a circular nozzle. In one instance, the homogenous blend throughput will be more than 10 gram per minute per orifice and in another instance greater than 20 gram per minute per orifice, and in yet another instance greater than 30 gram per minute per orifice. Additionally, for processes utilizing the slot nozzle, the homogenous blend throughput will be more than 0.5 kilogram per hour per meter width of the slot nozzle. In other slot nozzle processes, the homogenous blend throughput will be more than 5 kilogram per hour per meter width of the slot nozzle, or more than 20 kilogram per hour per meter width of the slot nozzle, or more than 40 kilogram per hour per meter width of the slot nozzle. In certain processes employing the slot nozzle, the homogenous blend throughput may exceed 60 kilogram per hour per meter width of the slot nozzle. There will likely be several orifices or nozzles operating at one time which further increases the total production throughput. The throughput, along with pressure, temperature, and velocity, are measured at the orifice or nozzle for both circular and slot nozzles.

Optionally, an entraining fluid can be used to induce a pulsating or fluctuating pressure field to help in forming fibers. Non-limiting examples of the entraining fluid are pressurized gas stream such as compressed air, nitrogen, oxygen, or any other fluid compatible (defined as reactive or inert) with the homogenous blend composition. The entertaining fluid with a high velocity can have a velocity near sonic speed (i.e. 330 m/s) or supersonic speeds (i.e. greater than 330 m/s). An entraining fluid with a low velocity will typically have a velocity of from 1 to 100 m/s, or from 3 to 50 m/s. It is desirable to have low turbulence in the entraining fluid stream 14 to minimize fiber-to-fiber entanglements, which usually occur due to high turbulence present in the fluid stream. The temperature of the entraining fluid 14 can be the same as the above fiberizing fluid stream, or a higher temperature to aid quenching of filaments, and ranges from −40° C. to 40° C., or from 0° C. to 25° C. The additional fluid stream may form a “curtain” or “shroud” around the filaments exiting from the nozzle. Any fluid stream may contribute to the fiberization of the homogenous blend and can thus generally be called fiberizing fluid stream.

The spunlaid processes in the present invention are made using a high speed spinning process as disclosed in U.S. Pat. Nos. 3,802,817; 5,545,371; 6,548,431 and 5,885,909. In these melt spinning processes, extruders supply molten polymer to melt pumps, which deliver specific volumes of molten polymer that transfer through a spinpack, composed of a multiplicity of capillaries formed into fibers, where the fibers are cooled through an air quenching zone and are pneumatically drawn down to reduce their size into highly attenuated fibers to increase fiber strength through molecular level fiber orientation. The drawn fibers are then deposited onto a porous belt, often referred to as a forming belt or forming table.

Spunlaid Process

Exemplary fibers forming the base substrate in the present invention include continuous filaments forming spunlaid fabrics. Spunlaid fabrics are defined as unbonded fabrics having basically no cohesive tensile properties formed from essentially continuous filaments. Continuous filaments are defined as fibers with high length to diameter ratios, with a ratio of more than 10,000:1. Continuous filaments in the present invention that compose the spunlaid fabric are not staple fibers, short cut fibers or other intentionally made short length fibers. The continuous filaments, defined as essentially continuous, in the present invention are on average, more than 100 mm long, or more than 200 mm long. The continuous filaments in the present invention are also not crimped, intentionally or unintentionally. Essentially discontinuous fibers and filaments are defined as having a length less than 100 mm long, or less than 50 mm long.

The spunlaid processes in the present invention are made using a high speed spinning process as disclosed in U.S. Pat. Nos. 3,802,817; 5,545,371; 6,548,431 and 5,885,909. In these melt spinning processes, extruders supply molten polymer to melt pumps, which deliver specific volumes of molten polymer that transfer through a spinpack, composed of a multiplicity of capillaries formed into fibers, where the fibers are cooled through an air quenching zone and are pneumatically drawn down to reduce their size into highly attenuated fibers to increase fiber strength through molecular level fiber orientation. The drawn fibers are then deposited onto a porous belt, often referred to as a forming belt or forming table.

The spunlaid process in the present invention used to make the continuous filaments will contain 100 to 10,000 capillaries per meter, or 200 to 7,000 capillaries per meter, or 500 to 5,000 capillaries per meter. The polymer mass flow rate per capillary in the present invention will be greater than 0.3 GHM (grams per hole per minute). The preferred range is from 0.35 GHM to 2 GHM, or between 0.4 GHM and 1 GHM, still more preferred between 0.45 GHM and 8 GHM and the most preferred range from 0.5 GHM to 0.6 GHM.

The spunlaid process in the present invention contains a single process step for making the highly attenuated, uncrimped continuous filaments. Extruded filaments are drawn through a zone of quench air where they are cooled and solidified as they are attenuated. Such spunlaid processes are disclosed in U.S. Pat. No. 3,338,992, U.S. Pat. No. 3,802,817, U.S. Pat. No. 4,233,014 U.S. Pat. No. 5,688,468, U.S. Pat. No. 6,548,431B1, U.S. Pat. No. 6,908,292B2 and US Application 2007/0057414A1. The technology described in EP 1340843B1 and EP 1323852B1 can also be used to produce the spunlaid nonwovens. The highly attenuated continuous filaments are directly drawn down from the exit of the polymer from the spinneret to the attenuation device, wherein the continuous filament diameter or denier does not change substantially as the spunlaid fabric is formed on the forming table

Exemplary polymeric materials include, but are not limited to, polypropylene and polypropylene copolymers, polyethylene and polyethylene copolymers, polyester and polyester copolymers, polyamide, polyimide, polylactic acid, polyhydroxyalkanoate, polyvinyl alcohol, ethylene vinyl alcohol, polyacrylates, and copolymers thereof and mixtures thereof, as well as the other mixture presented in the present invention. Other suitable polymeric materials include thermoplastic starch compositions as described in detail in U.S. publications 2003/0109605A1 and 2003/0091803. Still other suitable polymeric materials include ethylene acrylic acid, polyolefin carboxylic acid copolymers, and combinations thereof. The polymers described in U.S. Pat. No. 6,746,766, U.S. Pat. No. 6,818,295, U.S. Pat. No. 6,946,506 and US Published Application 03/0092343. Common thermoplastic polymer fiber grade materials are preferred, most notably polyester based resins, polypropylene based resins, polylactic acid based resin, polyhydroxyalkonoate based resin, and polyethylene based resin and combination thereof. Most preferred are polyester and polypropylene based resins.

One additional element in the present invention is the ability to utilize mixture compositions above 40 weigh percent (wt %) of a composition as described herein in the extrusion process, where the masterbatch level of a composition as described herein is combined with a lower concentration (down to 0 wt %) thermoplastic composition during extrusion to produce a composition as described herein within the target range.

In the process of spinning fibers, particularly as the temperature is increased above 105° C., typically it is desirable for residual water levels to be 1%, by weight of the fiber, or less, alternately 0.5% or less, or 0.15% or less.

Non-Woven Articles Made from Fibers

The fibers can be converted to nonwovens by different bonding methods. Continuous fibers can be formed into a web using industry standard spunbond type technologies while staple fibers can be formed into a web using industry standard carding, airlaid, or wetlaid technologies. Typical bonding methods include: calender (pressure and heat), thru-air heat, mechanical entanglement, hydrodynamic entanglement, needle punching, and chemical bonding and/or resin bonding. The calender, thru-air heat, and chemical bonding are the preferred bonding methods for the starch polymer fibers. Thermally bondable fibers are required for the pressurized heat and thru-air heat bonding methods.

The fibers of the present invention may also be bonded or combined with other synthetic or natural fibers to make nonwoven articles. The synthetic or natural fibers may be blended together in the forming process or used in discrete layers. Suitable synthetic fibers include fibers made from polypropylene, polyethylene, polyester, polyacrylates, and copolymers thereof and mixtures thereof. Natural fibers include cellulosic fibers and derivatives thereof. Suitable cellulosic fibers include those derived from any tree or vegetation, including hardwood fibers, softwood fibers, hemp, and cotton. Also included are fibers made from processed natural cellulosic resources such as rayon.

The fibers of the present invention may be used to make nonwovens, among other suitable articles. Nonwoven articles are defined as articles that contain greater than 15% of a plurality of fibers that are continuous or non-continuous and physically and/or chemically attached to one another. The nonwoven may be combined with additional nonwovens or films to produce a layered product used either by itself or as a component in a complex combination of other materials, such as a baby diaper or feminine care pad. Preferred articles are disposable, nonwoven articles. The resultant products may find use in filters for air, oil and water; vacuum cleaner filters; furnace filters; face masks; coffee filters, tea or coffee bags; thermal insulation materials and sound insulation materials; nonwovens for one-time use sanitary products such as diapers, feminine pads, tampons, and incontinence articles; biodegradable textile fabrics for improved moisture absorption and softness of wear such as micro fiber or breathable fabrics; an electrostatically charged, structured web for collecting and removing dust; reinforcements and webs for hard grades of paper, such as wrapping paper, writing paper, newsprint, corrugated paper board, and webs for tissue grades of paper such as toilet paper, paper towel, napkins and facial tissue; medical uses such as surgical drapes, wound dressing, bandages, dermal patches and self-dissolving sutures; and dental uses such as dental floss and toothbrush bristles. The fibrous web may also include odor absorbents, termite repellants, insecticides, rodenticides, and the like, for specific uses. The resultant product absorbs water and oil and may find use in oil or water spill clean-up, or controlled water retention and release for agricultural or horticultural applications. The resultant fibers or fiber webs may also be incorporated into other materials such as saw dust, wood pulp, plastics, and concrete, to form composite materials, which can be used as building materials such as walls, support beams, pressed boards, dry walls and backings, and ceiling tiles; other medical uses such as casts, splints, and tongue depressors; and in fireplace logs for decorative and/or burning purpose. Preferred articles of the present invention include disposable nonwovens for hygiene and medical applications. Hygiene applications include such items as wipes, diapers, feminine pads, and tampons.

Films

A composition as disclosed herein can be formed into a film and can comprise one of many different configurations, depending on the film properties desired. The properties of the film can be manipulated by varying, for example, the thickness, or in the case of multilayered films, the number of layers, the chemistry of the layers, i.e., hydrophobic or hydrophilic, and the types of polymers used to form the polymeric layers. The films disclosed herein can have a thickness of less than 300 μm, or can have a thickness of 300 μm or greater. Typically, when films have a thickness of 300 μm or greater, they are referred to as extruded sheets, but it is understood that the films disclosed herein embrace both films (e.g., with thicknesses less than 300 μm) and extruded sheets (e.g., with thicknesses of 300 μm or greater).

The films disclosed herein can be multi-layer films. The film can have at least two layers (e.g., a first film layer and a second film layer). The first film layer and the second film layer can be layered adjacent to each other to form the multi-layer film. A multi-layer film can have at least three layers (e.g., a first film layer, a second film layer and a third film layer). The second film layer can at least partially overlie at least one of an upper surface or a lower surface of the first film layer. The third film layer can at least partially overlie the second film layer such that the second film layer forms a core layer. It is contemplated that multi-layer films can include additional layers (e.g., binding layers, non-permeable layers, etc.).

It will be appreciated that multi-layer films can comprise from 2 layers to 1000 layers; or from 3 layers to 200 layers; or from 5 layers to 100 layers.

The films disclosed herein can have a thickness (e.g., caliper) from 10 microns to 200 microns; in certain or from 20 microns to 100 microns; or from 40 microns to 60 microns. For example, in the case of multi-layer films, each of the film layers can have a thickness less than 100 microns, or less than 50 microns, or less than 10 microns, or from 10 microns to 300 microns. It will be appreciated that the respective film layers can have substantially the same or different thicknesses.

Thickness of the films can be evaluated using various techniques, including the methodology set forth in ISO 4593:1993, Plastics—Film and sheeting—Determination of thickness by mechanical scanning. It will be appreciated that other suitable methods may be available to measure the thickness of the films described herein.

For multi-layer films, each respective layer can be formed from a composition described herein. The selection of compositions used to form the multi-layer film can have an impact on a number of physical parameters, and as such, can provide improved characteristics such as lower basis weights and higher tensile and seal strengths. Examples of commercial multi-layer films with improved characteristics are described in U.S. Pat. No. 7,588,706.

A multi-layer film can include a 3-layer arrangement wherein a first film layer and a third film layer form the skin layers and a second film layer is formed between the first film layer and the third film layer to form a core layer. The third film layer can be the same or different from the first film layer, such that the third film layer can comprise a composition as described herein. It will be appreciated that similar film layers could be used to form multi-layer films having more than 3 layers. For multi-layer films, it is contemplated having different concentration of amounts of compositions as described herein in different layers. One technique for using multi-layer films is to control the location of the composition as described herein. For example, in a 3 layer film, the core layer may contain the composition as described herein while the outer layer does not. Alternatively, the inner layer may not contain the composition as described herein and the outer layers do contain the composition as described herein.

If incompatible layers are to be adjacent in a multi-layer film, a tie layer can desirably be positioned between them. The purpose of the tie layer is to provide a transition and adequate adhesion between incompatible materials. An adhesive or tie layer is typically used between layers of layers that exhibit delamination when stretched, distorted, or deformed. The delamination can be either microscopic separation or macroscopic separation. In either event, the performance of the film may be compromised by this delamination. Consequently, a tie layer that exhibits adequate adhesion between the layers is used to limit or eliminate this delamination.

A tie layer is generally useful between incompatible materials. For instance, when a polyolefin and a copoly(ester-ether) are the adjacent layers, a tie layer is generally useful.

The tie layer is chosen according to the nature of the adjacent materials, and is compatible with and/or identical to one material (e.g. nonpolar and hydrophobic layer) and a reactive group which is compatible or interacts with the second material (e.g. polar and hydrophilic layer).

Suitable backbones for the tie layer include polyethylene (low density—LDPE, linear low density—LLDPE, high density—HDPE, and very low density—VLDPE) and polypropylene.

The reactive group may be a grafting monomer that is grafted to this backbone, and is or contains at least one alpha- or beta- ethylenically unsaturated carboxylic acid or anhydrides, or a derivative thereof. Examples of such carboxylic acids and anhydrides, which maybe mono-, di-, or polycarboxylic acids, are acrylic acid, methacrylic acid, maleic acid, fumaric acid, itaconic acid, crotonic acid, itaconic anhydride, maleic anhydride, and substituted malic anhydride, e.g. dimethyl maleic anhydride. Examples of derivatives of the unsaturated acids are salts, amides, imides and esters e.g. mono- and disodium maleate, acrylamide, maleimide, and diethyl fumarate.

A particularly preferred tie layer is a low molecular weight polymer of ethylene with 0.1 to 30 weight percent of one or more unsaturated monomers which can be copolymerized with ethylene, e.g., maleic acid, fumaric acid, acrylic acid, methacrylic acid, vinyl acetate, acrylonitrile, methacrylonitrile, butadiene, carbon monoxide, etc. Preferred are acrylic esters, maleic anhydride, vinyl acetate, and methyacrylic acid. Anhydrides are particularly preferred as grafting monomers with maleic anhydride being most preferred.

An exemplary class of materials suitable for use as a tie layer is a class of materials known as anhydride modified ethylene vinyl acetate sold by DuPont under the tradename Bynel®, e.g., Bynel® 3860. Another material suitable for use as a tie layer is an anhydride modified ethylene methyl acrylate also sold by DuPont under the tradename Bynel®, e.g., Bynel® 2169. Maleic anhydride graft polyolefin polymers suitable for use as tie layers are also available from Elf Atochem North America, Functional Polymers Division, of Philadelphia, Pa. as Orevac™.

Alternatively, a polymer suitable for use as a tie layer material can be incorporated into the composition of one or more of the layers of the films as disclosed herein. By such incorporation, the properties of the various layers are modified so as to improve their compatibility and reduce the risk of delamination.

Other intermediate layers besides tie layers can be used in the multi-layer film disclosed herein. For example, a layer of a polyolefin composition can be used between two outer layers of a hydrophilic resin to provide additional mechanical strength to the extruded web. Any number of intermediate layers may be used.

Examples of suitable thermoplastic materials for use in forming intermediate layers include polyethylene resins such as low density polyethylene (LDPE), linear low density polyethylene (LLDPE), ethylene vinyl acetate (EVA), ethylene methyl acrylate (EMA), polypropylene, and poly(vinyl chloride). Preferred polymeric layers of this type have mechanical properties that are substantially equivalent to those described above for the hydrophobic layer.

In addition to being formed from the compositions described herein, the films can further include additional additives. For example, opacifying agents can be added to one or more of the film layers. Such opacifying agents can include iron oxides, carbon black, aluminum, aluminum oxide, titanium dioxide, talc and combinations thereof. These opacifying agents can comprise 0.1% to 5% by weight of the film, or 0.3% to 3% of the film. It will be appreciated that other suitable opacifying agents can be employed and in various concentrations. Examples of opacifying agents are described in U.S. Pat. No. 6,653,523.

Furthermore, the films can comprise other additives, such as other polymers materials (e.g., a polypropylene, a polyethylene, a ethylene vinyl acetate, a polymethylpentene any combination thereof, or the like), a filler (e.g., glass, talc, calcium carbonate, or the like), a mold release agent, a flame retardant, an electrically conductive agent, an anti-static agent, a pigment, an antioxidant, an impact modifier, a stabilizer (e.g., a UV absorber), wetting agents, dyes, a film anti-static agent or any combination thereof. Film antistatic agents include cationic, anionic, and, nonionic agents. Cationic agents include ammonium, phosphonium and sulphonium cations, with alkyl group substitutions and an associated anion such as chloride, methosulphate, or nitrate. Anionic agents contemplated include alkylsulphonates. Nonionic agents include polyethylene glycols, organic stearates, organic amides, glycerol monostearate (GMS), alkyl di-ethanolamides, and ethoxylated amines.

Method of Making Films

The film as disclosed herein can be processed using conventional procedures for producing films on conventional coextruded film-making equipment. In general, polymers can be melt processed into films using either cast or blown film extrusion methods both of which are described in Plastics Extrusion Technology-2nd Ed., by Allan A. Griff (Van Nostrand Reinhold-1976).

Cast film is extruded through a linear slot die. Generally, the flat web is cooled on a large moving polished metal roll (chill roll). It quickly cools, and peels off the first roll, passes over one or more auxiliary rolls, then through a set of rubber-coated pull or “haul-off” rolls, and finally to a winder.

In blown film extrusion, the melt is extruded upward through a thin annular die opening. This process is also referred to as tubular film extrusion. Air is introduced through the center of the die to inflate the tube and causes it to expand. A moving bubble is thus formed which is held at constant size by simultaneous control of internal air pressure, extrusion rate, and haul-off speed. The tube of film is cooled by air blown through one or more chill rings surrounding the tube. The tube is next collapsed by drawing it into a flattened frame through a pair of pull rolls and into a winder.

A coextrusion process requires more than one extruder and either a coextrusion feedblock or a multi-manifold die system or combination of the two to achieve a multilayer film structure. U.S. Pat. Nos. 4,152,387 and 4,197,069, incorporated herein by reference, disclose the feedblock and multi-manifold die principle of coextrusion. Multiple extruders are connected to the feedblock which can employ moveable flow dividers to proportionally change the geometry of each individual flow channel in direct relation to the volume of polymer passing through the flow channels. The flow channels are designed such that, at their point of confluence, the materials flow together at the same velocities and pressure, minimizing interfacial stress and flow instabilities. Once the materials are joined in the feedblock, they flow into a single manifold die as a composite structure. Other examples of feedblock and die systems are disclosed in Extrusion Dies for Plastics and Rubber, W. Michaeli, Hanser, New York, 2nd Ed., 1992, hereby incorporated herein by reference. It may be important in such processes that the melt viscosities, normal stress differences, and melt temperatures of the material do not differ too greatly. Otherwise, layer encapsulation or flow instabilities may result in the die leading to poor control of layer thickness distribution and defects from non-planar interfaces (e.g. fish eye) in the multilayer film.

An alternative to feedblock coextrusion is a multi-manifold or vane die as disclosed in U.S. Pat. Nos. 4,152,387, 4,197,069, and 4,533,308, incorporated herein by reference. Whereas in the feedblock system melt streams are brought together outside and prior to entering the die body, in a multi-manifold or vane die each melt stream has its own manifold in the die where the polymers spread independently in their respective manifolds. The melt streams are married near the die exit with each melt stream at full die width. Moveable vanes provide adjustability of the exit of each flow channel in direct proportion to the volume of material flowing through it, allowing the melts to flow together at the same velocity, pressure, and desired width.

Since the melt flow properties and melt temperatures of polymers vary widely, use of a vane die has several advantages. The die lends itself toward thermal isolation characteristics wherein polymers of greatly differing melt temperatures, for example up to 175° F. (80° C.), can be processed together.

Each manifold in a vane die can be designed and tailored to a specific polymer. Thus the flow of each polymer is influenced only by the design of its manifold, and not forces imposed by other polymers. This allows materials with greatly differing melt viscosities to be coextruded into multilayer films. In addition, the vane die also provides the ability to tailor the width of individual manifolds, such that an internal layer can be completely surrounded by the outer layer leaving no exposed edges. The feedblock systems and vane dies can be used to achieve more complex multilayer structures.

One of skill in the art will recognize that the size of an extruder used to produce the films as disclosed herein depends on the desired production rate and that several sizes of extruders may be used. Suitable examples include extruders having a 1 inch (2.5 cm) to 1.5 inch (3.7 cm) diameter with a length/diameter ratio of 24 or 30. If required by greater production demands, the extruder diameter can range upwards. For example, extruders having a diameter between 2.5 inches (6.4 cm) and 4 inches (10 cm) can be used to produce the films of the present invention. A general purpose screw may be used. A suitable feedblock is a single temperature zone, fixed plate block. The distribution plate is machined to provide specific layer thicknesses. For example, for a three layer film, the plate provides layers in an 80/10/10 thickness arrangement, a suitable die is a single temperature zone flat die with “flex-lip” die gap adjustment. The die gap is typically adjusted to be less than 0.020 inches (0.5 mm) and each segment is adjusted to provide for uniform thickness across the web. Any size die may be used as production needs may require, however, 10-14 inch (25-35 cm) dies have been found to be suitable. The chill roll is typically water-cooled. Edge pinning is generally used and occasionally an air knife may be employed.

For some coextruded films, the placement of a tacky hydrophilic material onto the chill roll may be necessary. When the arrangement places the tacky material onto the chill roll, release paper may be fed between the die and the chill roll to minimize contact of the tacky material with the rolls. However, a preferred arrangement is to extrude the tacky material on the side away from the chill roll. This arrangement generally avoids sticking material onto the chill roll. An extra stripping roll placed above the chill roll may also assist the removal of tacky material and also can provide for additional residence time on the chill roll to assist cooling the film.

Occasionally, tacky material may stick to downstream rolls. This problem may be minimized by either placing a low surface energy (e.g. Teflon®) sleeve on the affected rolls, wrapping Teflon® tape on the effected rolls, or by feeding release paper in front of the effected rolls. Finally, if it appears that the tacky material may block to itself on the wound roll, release paper may be added immediately prior to winding. This is a standard method of preventing blocking of film during storage on wound rolls. Processing aids, release agents or contaminants should be minimized. In some cases, these additives can bloom to the surface and reduce the surface energy (raise the contact angle) of the hydrophilic surface.

An alternative method of making the multi-layer films as disclosed herein is to extrude a web comprising a material suitable for one of the individual layers. Extrusion methods as known to the art for forming flat films are suitable. Such webs may then be laminated to form a multi-layer film suitable for formation into a fluid pervious web using the methods discussed below. As will be recognized, a suitable material, such as a hot melt adhesive, can be used to join the webs to form the multi-layer film. A preferred adhesive is a pressure sensitive hot melt adhesive such as a linear styrene isoprene styrene (“SIS”) hotmelt adhesive, but it is anticipated that other adhesives, such as polyester of polyamide powdered adhesives, hotmelt adhesives with a compatibilizer such as polyester, polyamide or low residual monomer polyurethanes, other hotmelt adhesives, or other pressure sensitive adhesives could be utilized in making the multi-layer films of the present invention.

In another alternative method of making the films as disclosed herein, a base or carrier web can be separately extruded and one or more layers can be extruded thereon using an extrusion coating process to form a film. Desirably, the carrier web passes under an extrusion die at a speed that is coordinated with the extruder speed so as to form a very thin film having a thickness of less than 25 microns. The molten polymer and the carrier web are brought into intimate contact as the molten polymer cools and bonds with the carrier web.

As noted above, a tie layer may enhance bonding between the layers. Contact and bonding are also normally enhanced by passing the layers through a nip formed between two rolls. The bonding may be further enhanced by subjecting the surface of the carrier web that is to contact the film to surface treatment, such as corona treatment, as is known in the art and described in Modern Plastics Encyclopedia Handbook, p. 236 (1994).

If a monolayer film layer is produced via tubular film (i.e., blown film techniques) or flat die (i.e., cast film) as described by K. R. Osborn and W. A. Jenkins in “Plastic Films, Technology and Packaging Applications” (Technomic Publishing Co., Inc. (1992)), then the film can go through an additional post-extrusion step of adhesive or extrusion lamination to other packaging material layers to form a multi-layer film. If the film is a coextrusion of two or more layers, the film can still be laminated to additional layers of packaging materials, depending on the other physical requirements of the final film. “Laminations Vs. Coextrusion” by D. Dumbleton (Converting Magazine (September 1992), also discusses lamination versus coextrusion. The films contemplated herein can also go through other post extrusion techniques, such as a biaxial orientation process.

Fluid Pervious Webs

The films as disclosed herein can be formed into fluid pervious webs suitable for use as a topsheet in an absorbent article. As is described below, the fluid pervious web is desirably formed by macroscopically expanding a film as disclosed herein. The fluid pervious web contains a plurality of macroapertures, microapertures or both. Macroapertures and/or microapertures give the fluid pervious web a more consumer-preferred fiber-like or cloth-like appearance than webs apertured by methods such as embossing or perforation (e.g. using a roll with a multiplicity of pins) as are known to the art. One of skill in the art will recognize that such methods of providing apertures to a film are also useful for providing apertures to the films as disclosed herein. Although the fluid pervious web is described herein as a topsheet for use in an absorbent article, one having ordinary skill in the art will appreciate these webs have other uses, such as bandages, agricultural coverings, and similar uses where it is desirable to manage fluid flow through a surface.

The macro and microapertures are formed by applying a high pressure fluid jet comprised of water or the like against one surface of the film, desirably while applying a vacuum adjacent the opposite surface of the film. In general, the film is supported on one surface of a forming structure having opposed surfaces. The forming structure is provided with a multiplicity of apertures therethrough which place the opposed surfaces in fluid communication with one another. While the forming structure may be stationary or moving, an exemplary execution uses the forming structure as part of a continuous process where the film has a direction of travel and the forming structure carries the film in the direction of travel while supporting the film. The fluid jet and, desirably, the vacuum cooperate to provide a fluid pressure differential across the thickness of the film causing the film to be urged into conformity with the forming structure and to rupture in areas that coincide with the apertures in the forming structure.

The film passes over two forming structures in sequence. The first forming structure being provided with a multiplicity of fine scale apertures which, on exposure to the aforementioned fluid pressure differential, cause formation of microapertures in the web of film. The second forming structure exhibits a macroscopic, three-dimensional cross section defined by a multiplicity of macroscopic cross section apertures. On exposure to a second fluid pressure differential the film substantially conforms to the second forming structure while substantially maintaining the integrity of the fine scale apertures.

Such methods of aperturing are known as “hydroformation” and are described in greater detail in U.S. Pat. Nos. 4,609,518; 4,629,643; 4,637,819; 4,681,793; 4,695,422; 4,778,644; 4,839,216; and 4,846,821, the disclosures of each being incorporated herein by reference.

The apertured web can also be formed by methods such as vacuum formation and using mechanical methods such as punching. Vacuum formation is disclosed in U.S. Pat. No. 4,463,045, the disclosure of which is incorporated herein by reference. Examples of mechanical methods are disclosed in U.S. Pat. Nos. 4,798,604; 4,780,352; and 3,566,726, the disclosures of which are incorporated herein by reference.

Molded Articles

Compositions as disclosed herein can be formed into molded or extruded articles. A molded article is an object that is formed when injected, compressed, or blown by means of a gas into shape defined by a female mold. Molded or extruded articles may be solid objects such as, for example, toys, or hollow objects such as, for example, bottles, containers, tampon applicators, applicators for insertion of medications into bodily orifices, medical equipment for single use, surgical equipment, or the like. Molded articles and processes for preparing them are generally described, e.g., in U.S. Pat. No. 6,730,057 and U.S. Patent Publication No. 2009/0269527, each of which is incorporated by reference herein.

The composition disclosed herein is suitable for producing container articles, such as personal care products, household cleaning products, and laundry detergent products, and packaging for such articles. Personal care products include cosmetics, hair care, skin care, and oral care products, i.e., shampoo, soap, tooth paste. Accordingly, further disclosed herein is product packaging, such as containers or bottles comprising the composition described herein. A container can refer to one or more elements of a container, e.g., body, cap, nozzle, handle, or a container in its entirety, e.g., body and cap.

Furthermore, the molded articles can comprise other additives, such as other polymers materials (e.g., a polypropylene, a polyethylene, a ethylene vinyl acetate, a polymethylpentene any combination thereof, or the like), a filler (e.g., glass, talc, calcium carbonate, or the like), a mold release agent, a flame retardant, an electrically conductive agent, a film anti-static agent, a pigment, an antioxidant, an impact modifier, a stabilizer (e.g., a UV absorber), wetting agents, dyes, or any combination thereof. Molded article antistatic agents include cationic, anionic, and, desirably, nonionic agents. Cationic agents include ammonium, phosphonium and sulphonium cations, with alkyl group substitutions and an associated anion such as chloride, methosulphate, or nitrate. Anionic agents contemplated include alkylsulphonates. Nonionic agents include polyethylene glycols, organic stearates, organic amides, glycerol monostearate (GMS), alkyl di-ethanolamides, and ethoxylated amines.

Method of Making Molded Articles

The molded articles of the compositions as disclosed herein can be prepared using a variety of techniques, such as injection molding, blow molding, compression molding, or extrusion of pipes, tubes, profiles, or cables.

Injection molding of a composition as disclosed herein is a multi-step process by which the composition is heated until it is molten, then forced into a closed mold where it is shaped, and finally solidified by cooling. The composition is melt processed at melting temperatures less than 180° C., more typically less than 160° C. to minimize unwanted thermal degradation. Three common types of machines that are used in injection molding are ram, screw plasticator with injection, and reciprocating screw devices (see Encyclopedia of Polymer Science and Engineering, Vol. 8, pp. 102-138, John Wiley and Sons, New York, 1987 (“EPSE-3”).

A ram injection molding machine is composed of a cylinder, spreader, and plunger. The plunger forces the melt in the mold. A screw plasticator with a second stage injection consists of a plasticator, directional valve, a cylinder without a spreader, and a ram. After plastication by the screw, the ram forces the melt into the mold. A reciprocating screw injection machine is composed of a barrel and a screw. The screw rotates to melt and mix the material and then moves forward to force the melt into the mold.

An example of a suitable injection molding machine is the Engel Tiebarless ES 60 TL apparatus having a mold, a nozzle, and a barrel that is divided into zones wherein each zone is equipped with thermocouples and temperature-control units. The zones of the injection molding machine can be described as front, center, and rear zones whereby the pellets are introduced into the front zone under controlled temperature. The temperature of the nozzle, mold, and barrel components of the injection molding machine can vary according to the melt processing temperature of the compositions and the molds used, but will typically be in the following ranges: nozzle, 120-170° C.; front zone, 100-160° C.; center zone 100-160° C.; rear zone 60-150° C.; and mold, 5-50° C. Other typical processing conditions include an injection pressure of 2100 kPa to 13,790 kPa, a holding pressure of 2800 kPa to 11,030 kPa, a hold time of 2 seconds to 15 seconds, and an injection speed of from 2 cm/sec to 20 cm/sec. Examples of other suitable injection molding machines include Van Dorn Model 150-RS-8F, Battenfeld Model 1600, and Engel Model ES80.

Compression molding involves charging a quantity of a composition as disclosed herein in the lower half of an open die. The top and bottom halves of the die are brought together under pressure, and then molten composition conforms to the shape of the die. The mold is then cooled to harden the plastic.

Blow molding is used for producing bottles and other hollow objects (see EPSE-3). In this process, a tube of molten composition known as a parison is extruded into a closed, hollow mold. The parison is then expanded by a gas, thrusting the composition against the walls of a mold. Subsequent cooling hardens the plastic. The mold is then opened and the article removed.

Blow molding has a number of advantages over injection molding. The pressures used are much lower than injection molding. Blow molding can be typically accomplished at pressures of 25-100 psi between the plastic and the mold surface. By comparison, injection molding pressures can reach 10,000 to 20,000 psi (see EPSE-3). In cases where the composition has a have molecular weights too high for easy flow through molds, blow molding is the technique of choice. High molecular weight polymers often have better properties than low molecular weight analogs, for example high molecular weight materials have greater resistance to environmental stress cracking. (see EPSE-3). It is possible to make extremely thin walls in products with blow molding. This means less composition is used, and solidification times are shorter, resulting in lower costs through material conservation and higher throughput. Another important feature of blow molding is that since it uses only a female mold, slight changes in extrusion conditions at the parison nozzle can vary wall thickness (see EPSE-3). This is an advantage with structures whose necessary wall thicknesses cannot be predicted in advance. Evaluation of articles of several thicknesses can be undertaken, and the thinnest, thus lightest and cheapest, article that meets specifications can be used.

Extrusion is used to form extruded articles, such as pipes, tubes, rods, cables, or profile shapes. Compositions are fed into a heating chamber and moved through the chamber by a continuously revolving screw. Single screw or twin screw extruders are commonly used for plastic extrusion. The composition is plasticated and conveyed through a pipe die head. A haul-off draws the pipe through the calibration and cooling section with a calibration die, a vacuum tank calibration unit and a cooling unit. Rigid pipes are cut to length while flexible pipes are wound. Profile extrusion may be carried out in a one step process. Extrusion procedures are further described in Hensen, F., Plastic Extrusion Technology, p 43-100.

Tampon applicators are molded or extruded in a desired shape or configuration using a variety of molding or extrusion techniques to provide an applicator comprising an outer tubular member and an inner tubular member or plunger. The outer tubular member and plunger can be made by different molding or extrusion techniques. The outer member can be molded or extruded from a composition as disclosed herein and the plunger from another material.

Generally, the process of making tampon applicators involves charging a composition as disclosed herein into a compounder, and the composition is melt blended and processed to pellets. The pellets are then constructed into tampon applicators using an injection molding apparatus. The injection molding process is typically carried out under controlled temperature, time, and speed and involves melt processing the composition such that the melted composition is injected into a mold, cooled, and molded into a desired plastic object. Alternatively, the composition can be charged directly into an injection molding apparatus and the melt molded into the desired tampon applicator.

One example of a procedure of making tampon applicators involves extruding the composition at a temperature above the melting temperature of the composition to form a rod, chopping the rod into pellets, and injection molding the pellets into the desired tampon applicator form.

The compounders that are commonly used to melt blend thermoplastic compositions are generally single-screw extruders, twin-screw extruders, and kneader extruders. Examples of commercially available extruders suitable for use herein include the Black-Clawson single-screw extruders, the Werner and Pfleiderer co-rotating twin-screw extruders, the HAAKE®. Polylab System counter-rotating twin screw extruders, and the Buss kneader extruders. General discussions of polymer compounding and extrusion molding are disclosed in the Encyclopedia of Polymer Science and Engineering, Vol. 6, pp. 571-631, 1986, and Vol. 11, pp. 262-285, 1988; John Wiley and Sons, New York.

The tampon applicators can be packaged in any suitable wrapper provided that the wrapper is soil proof and disposable with dry waste. Wrappers made from biodegradable materials that create minimal or no environmental concerns for their disposal are contemplated. It is also contemplated that the tampon applicators can be packaged in wrappers made from paper, nonwoven, cellulose, thermoplastic, or any other suitable material, or combinations of these materials.

Regardless of the method by which the molded article is made, the process involves an annealing cycle. The annealing cycle time is the holding time plus cooling time of the process of making the molded article. With process conditions substantially optimized for a particular mold, an annealing cycle time is a function of the composition. Process conditions substantially optimized are the temperature settings of the zones, nozzle, and mold of the molding apparatus, the shot size, the injection pressure, and the hold pressure. Annealing cycle times provided herein are at least ten seconds less than an annealing cycle time to form a molded or extruded article from a composition as disclosed herein. A dogbone tensile bar having dimensions of ½ inch length (L) (12.7 mm)×⅛ inch width (W) (3.175 mm)× 1/16 inch height (H) (1.5875 mm) made using an Engel Tiebarless ES 60 TL injection molding machine as provided herein provides a standard article as representative of a molded or extruded article for measuring annealing cycle times herein.

The holding time is the length of time that a part is held under a holding pressure after initial material injection. The result is that air bubbles and/or sink marks, desirably both, are not visually observable on the exterior surface, desirably both exterior and interior surfaces (if applicable), with the naked eye (of a person with 20-20 vision and no vision defects) from a distance of 20 cm from the surface of the molded or extruded article. This is to ensure the accuracy and cosmetic quality of the part. Shrinkage is taken into account by the mold design. However, shrinkage of 1.5% to 5%, from 1.0% to 2.5%, or 1.2% to 2.0% can occur. A shorter holding time is determined by reducing the holding time until parts do not pass the visual test described supra, do not conform to the shape and texture of the mold, are not completely filled, or exhibit excessive shrinkage. The length of time prior to the time at which such events occur is then recorded as a shorter holding time.

The cooling time is the time for the part to become solidified in the mold and to be ejected readily from the mold. The mold includes at least two parts, so that the molded article is readily removed. For removal, the mold is opened at the parting line of the two parts. The finished molded part can be removed manually from the opened mold, or it can be pushed out automatically without human intervention by an ejector system as the mold is being opened. Depending on the part geometry, such ejectors may consist of pins or rings, embedded in the mold, that can be pushed forward when the mold is open. For example, the mold can contain standard dial-type or mechanical rod-type ejector pins to mechanically assist in the ejection of the molded parts. Suitable size rod-type ejector pins are ⅛″ (3.175 mm), and the like. A shorter cooling time is determined by reducing the cooling time until parts become hung up on the mold and cannot readily pop out. The length of time prior to the time at which the part becomes hung up is then recorded as a shorter cooling time.

Processing temperatures that are set low enough to avoid thermal degradation of the composition, yet high enough to allow free flow of the composition for molding are used The composition is melt processed at melting temperatures less than 180° C. or, more typically, less than 160° C. to minimize thermal degradation. In general, polymers can thermally degrade when exposed to temperatures above the degradation temperature after melt for a period of time. As is understood by those skilled in the art in light of the present disclosure, the particular time required to cause thermal degradation will depend upon the particular composition, the length of time above the melt temperature (Tm), and the number of degrees above the Tm. The temperatures can be as low as reasonably possible to allow free-flow of the polymer melt in order to minimize risk of thermal degradation. During extrusion, high shear in the extruder increases the temperature in the extruder higher than the set temperature. Therefore, the set temperatures may be lower than the melt temperature of the material. Low processing temperatures also help to reduce cycle time. For example, without limitation, the set temperature of the nozzle and barrel components of the injection molding machine can vary according to the melt processing temperature of the polymeric material and the type of molds used and can be from 20° C. below the Tm to 30° C. above the Tm, but will typically be in the following ranges: nozzle, 120-170° C.; front zone, 100-160° C.; center zone, 100-160° C. zone, 60-160° C. The set mold temperature of the injection molding machine is also dependent on the type of composition and the type of molds used. A higher mold temperature helps polymers crystallize faster and reduces the cycle time. However, if the mold temperature is too high, the parts may come out of the mold deformed. Non-limiting examples of the mold temperature include 5-60° C. or 25-50° C.

Molding injection speed is dependent on the flow rate of the compositions. The higher flow rate, the lower viscosity, the lower speed is needed for the injection molding. Injection speed can range from 5 cm/sec to 20 cm/sec, in one execution, the injection speed is 10 cm/sec. If the viscosity is high, the injection speed is increased so that extruder pressure pushes the melt materials into the mold to fill the mold. The injection molding pressure is dependent on the processing temperature and shot size. Free flow is dependent upon the injection pressure reading not higher than 14 Mpa.

### Properties of Compositions

The compositions as disclosed herein can have one or more of the following properties, providing an advantage over known thermoplastic compositions. These benefits can be present alone or in combination.

The polymeric composition containing soap can be substantially compatible with at least a second thermoplastic polymer. As used herein, the term “substantially compatible” means when heated to a temperature above the softening and/or the melting temperature of the thermoplastic polymers, the composition is capable of forming a substantially homogeneous mixture with shear or extension, for application such as fiber spinning, film production and production of molded articles. A specific example is a compatibilizer containing an intimate admixture of polypropylene and zinc stearate combined with a blend of polypropylene and polylactic acid to produce a substantially compatible composition.

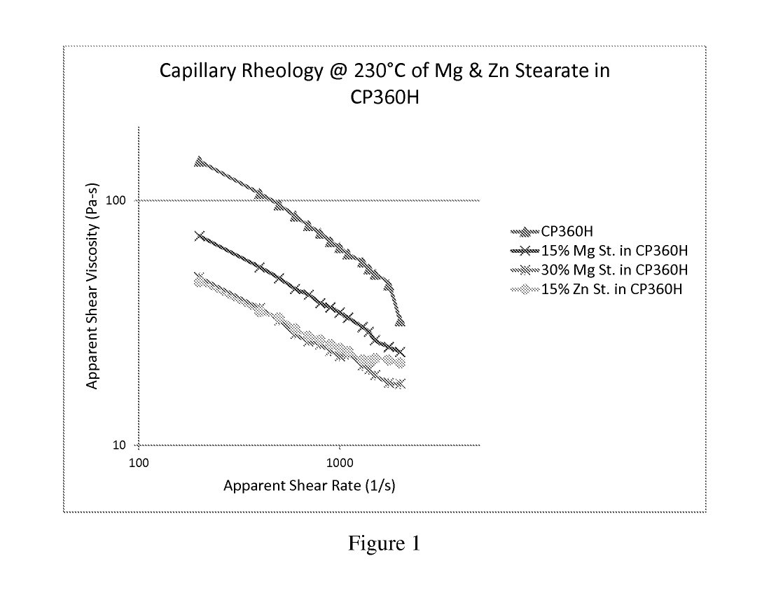

Shear Viscosity Reduction: As shown in FIG. 1, addition of the soaps, e.g., magnesium stearate and zinc stearate, to the thermoplastic polymer, e.g., Braskem CP-360H, reduces the viscosity of the thermoplastic polymer (here, polypropylene in the presence of the molten soap). Viscosity reduction is a process improvement as it can allow for effectively higher polymer flow rates by having a reduced process pressure (lower shear viscosity), or can allow for an increase in polymer molecular weight, which improves the material strength. Without the presence of the soap, it may not be possible to process the polymer with a high polymer flow rate at existing process conditions in a suitable way.

Sustainable Content: Inclusion of sustainable materials into the existing polymeric system is a strongly desired property. Materials that can be replaced every year through natural growth cycles contribute to overall lower environmental impact and are desired. For example, the polymer-soap composition can comprise greater than 10%, or greater than 50%, or from 30-100%, or from 1-100% renewable materials, based upon the total weight of the polymer-soap composition.

Pigmentation: Adding pigments to polymers often involves using expensive inorganic compounds that are particles within the polymer matrix. These particles are often large and can interfere in the processing of the composition. Using a soap as disclosed herein, because of the fine dispersion (as measured by droplet size) and uniform distribution throughout, the thermoplastic polymer allows for coloration, such as via traditional ink compounds. Soy ink is widely used in paper publication and does not impact processability.

Fragrance: Because the soaps, for example, can contain perfumes much more preferentially than the base thermoplastic polymer, the present composition can be used to contain scents that are beneficial for end-use.

Surface feel: The presence of the soap can change the surface properties of the composition, compared to a thermoplastic polymer composition without a soap, making it feel softer.

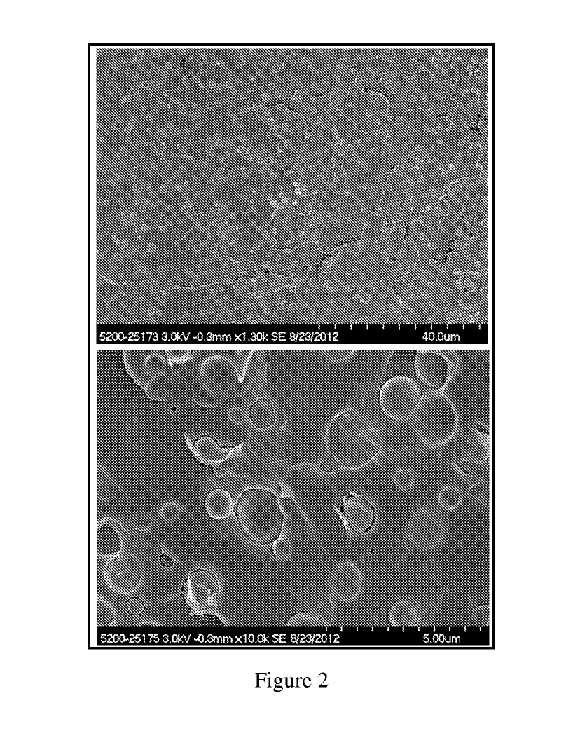

Morphology: Benefits are delivered via the morphology produced in production of the compositions. The morphology is produced by a combination of intensive mixing and rapid crystallization. The intensive mixing comes from the compounding process used and rapid crystallization comes from the cooling process used. High intensity mixing is desired and rapid crystallization is used to preserves the fine pore size and relatively uniform pore size distribution. FIG. 2 shows magnesium stearate in Braskem CP-360H, with the small pore sizes of less than 10 μm, less than 5 μm, or less than 1 μm.

### Examples 1-13

Polymers: The primary polymers used in this work are polypropylene (PP) and polyethylene (PE), but other polymers can be used (see, e.g., U.S. Pat. No. 6,783,854, which provides a comprehensive list of polymers that are possible, although not all have been tested). Specific polymers evaluated and the materials used in formulating the examples include:

### Polypropylene(PP) Resins:

Braskem; PP HP CP 360 H Nat; Batch#PACL2G0621; Product Code#662564; 35 melt flow rate Ziegler-Natta resin.
Braskem; PP HP FT 200 WV Nat; Batch#TXIF1L2201; Product Code#632043; 20 melt flow rate Ziegler-Natta resin.

### Soaps:

Magnesium stearate(MgSt1): Spectrum Chemical Manufacturing Corporation; Product#MA130; Grade: NF, BP, JP.; Lot#XR0347.
Magnesium stearate(MgSt2): Baerlocher Production USA, LLC.; Magnesium Stearate AV-US; granular form; mp>100° C.
Calcium stearate(CaSt1): Alfa Aesar, A Johnson Matthey Company; powder; Product#39423; Lot#G19X013; mp 179-180° C.; FW 607.04.
Calcium stearate(CaSt2): Baerlocher Production USA, LLC.; Calcium Stearate HP Granular Hydense; Code#5862; granular form; mp range 140-160° C.
Zinc stearate(ZnSt1): Sigma Aldrich Company, LLC.; Product#26423; Lot#SZB2600V; purum; 10-12% Zn basis; Product of Germany.
Zinc stearate(ZnSt2): Baerlocher Production USA, LLC.; Zinc Stearate TX Veg Hydense; Code#8600; pastille form; mp 120-122° C.

Compositions were made using a Baker Perkins CT-25 Twin Screw extruder and a Werner & Pfleiderer 30 mm twin screw extruder (WP-30) as noted in Tables 1-2.

Examples 1-8, 10, and 12-13 were 1 made with polypropylene resin CP360H. Examples 9 and 11 were made using an injection molding grade polypropylene, FT200WV. All samples were successfully quenched in a water bath and subsequently pelletized. No die buildup was noticed for any of the samples. Very little fuming was evident for samples coming out of the die except for samples with zinc stearate, where some fuming/vapor was evident coming off the melt strands exiting the die. Metal soap samples compounded with the B&P CT-25 appeared more homogeneous, better mixed, and more uniform than similar samples made with W&P 30 mm twin screw. Compositions were made using a Baker Perkins CT-25 and W&P-30 screw, with the zones set as noted in Tables 1-2.

TABLE 1
Baker Perkins CT-25 (BP-25) Twin Screw Compounding with Polypropylene Resins: Lipids/Soaps

| | | | Ratio | | Twin-Screw Temperature Profile (° C.) | | | | | | | | | | | |
|---|---|---|---|---|---|---|---|---|---|---|---|---|---|---|---|---|
| Example | Polymer | Additive | Polymer | Additive | Z1 | Z2 | Z3 | Z4 | Z5 | Z6 | Z7 | Z8 | Z9 | Z10 | Z11 | Die |
| 1 | CP360 | MgSt1 | 90 | 10 | 40 | 70 | 70 | 140 | 240 | 250 | 250 | 255 | 255 | 260 | 255 | 170 |
| 2 | CP360 | MgSt1 | 70 | 30 | 40 | 70 | 70 | 140 | 240 | 250 | 250 | 255 | 255 | 260 | 255 | 170 |
| 3 | CP360 | ZnSt2 | 90 | 10 | 40 | 190 | 230 | 230 | 230 | 230 | 230 | 230 | 230 | 230 | 230 | 190 |
| 4 | CP360 | ZnSt2 | 70 | 30 | 40 | 190 | 230 | 230 | 230 | 230 | 230 | 230 | 230 | 230 | 230 | 190 |
| 5 | CP360 | CaSt2 | 80 | 20 | 40 | 50 | 90 | 200 | 240 | 240 | 240 | 240 | 240 | 240 | 240 | 210 |

| | Melt | Additive | | | | Total | Pellet- | |
|---|---|---|---|---|---|---|---|---|
| | Temperature | Temperature | Screw | Screw | Torque | Throughput | ization | |
| Example | (° C.) | (° C.) | RPM | Type | (%) | (lbs/hour) | Method | Comments |
| 1 | 203 | 25 | 800 | Intensive | 23 | 50 | Strand | Vacuum |
| | | | | | | | | Zone 10 |
| 2 | 203 | 25 | 800 | Intensive | 17 | 40 | Strand | Vacuum |
| | | | | | | | | Zone 10 |
| 3 | 192 | 25 | 400 | High | 50 | 100 | Strand | Vacuum |
| | | | | | | | | Zone 10 |
| 4 | 192 | 25 | 800 | High | 14 | 80 | Strand | No |
| | | | | | | | | vacuum |
| 5 | 209 | 25 | 700 | High | 25 | 50 | Strand | Vacuum |
| | | | | | | | | Zone 10 |

TABLE 2
Werner & Pfleiderer (W&P) 30 mm Twin Screw Compounding with Polypropylene Resins: Soaps

| | | | Ratio | | Twin-Screw Temperature Profile (° C.) | | | | | | | | | | | | |
|---|---|---|---|---|---|---|---|---|---|---|---|---|---|---|---|---|---|
| Ex. | Polymer | Additive | Polymer | Additive | Z1 | Z2 | Z3 | Z4 | Z5 | Z6 | Z7 | Z8 | Z9 | Z10 | Z11 | Z12 | Die |
| 6 | CP360 | MgSt1 | 85 | 15 | 40 | 229 | 229 | 229 | 229 | 221 | 221 | 221 | 185 | 171 | 165 | 165 | 165 |
| 7 | CP360 | MgSt1 | 70 | 30 | 40 | 229 | 229 | 229 | 229 | 221 | 221 | 221 | 185 | 171 | 165 | 165 | 165 |
| 8 | CP360 | MgSt1 | 85 | 15 | 40 | 221 | 229 | 238 | 238 | 238 | 238 | 238 | 238 | 232 | 232 | 232 | 176 |
| 9 | FT200WV | MgSt1 | 90 | 10 | 40 | 221 | 229 | 238 | 238 | 238 | 238 | 238 | 238 | 232 | 232 | 232 | 176 |
| 10 | CP360 | CaSt1 | 85 | 15 | 40 | 221 | 229 | 238 | 238 | 238 | 238 | 238 | 238 | 232 | 232 | 232 | 176 |
| 11 | FT200WV | CaSt1 | 90 | 10 | 40 | 221 | 229 | 238 | 238 | 238 | 238 | 238 | 238 | 232 | 232 | 238 | 176 |
| 12 | CP360 | ZnSt1 | 85 | 15 | 40 | 260 | 260 | 260 | 260 | 238 | 238 | 238 | 238 | 232 | 232 | 232 | 176 |
| 13 | CP360 | ZnSt1 | 70 | 30 | 40 | 260 | 260 | 260 | 260 | 238 | 238 | 238 | 238 | 232 | 232 | 232 | 176 |

| | Melt | | | | Total | Pellet- | Pelletization | |
|---|---|---|---|---|---|---|---|---|
| | Temperature | Screw | Screw | Torque | Throughput | ization | Success | |
| Ex. | (° C.) | RPM | Type | (%) | (lbs/hour) | Method | or Fail ? | Comments |
| 6 | 175 | 300 | Moderate | 20 | 40 | Strand | Success | No issues |
| 7 | 176 | 300 | Moderate | 15 | 30 | Strand | Success | No issues |
| 8 | 183 | 300 | Moderate | 18 | 40 | Strand | Success | Vacuum on |
| | | | | | | | | Z6 and Z11 |
| 9 | 182 | 300 | Moderate | 19 | 40 | Strand | Success | Vacuum on |
| | | | | | | | | Z6 and Z11 |
| 10 | 185 | 300 | Moderate | 18 | 40 | Strand | Success | Vacuum on |
| | | | | | | | | Z6 and Z11 |
| 11 | 185 | 300 | Moderate | 17 | 40 | Strand | Success | Vacuum on |
| | | | | | | | | Z6 and Z11 |
| 12 | 180 | 200 | Moderate | 8 | 25 | Strand | Success | Vacuum on |
| | | | | | | | | Z11 |
| 13 | 176 | 200 | Moderate | 4 | 25 | Strand | Success | Vacuum on |
| | | | | | | | | Z11 |

Examples 1-13 were made using polypropylene resins. During stable extrusion, no significant amount of soap separated from the formulation strand (>99 wt % made it through the pelletizer). Saturation of the composition can be noted by separation of the polymer and soap from each other at the end of the twin-screw. The saturation point of the soap in the composition can change based on the soap and polymer combination, along with the process conditions. The practical utility is that the soap and polymer remain admixed and do not separate, which is a function of the mixing level and quench rate for proper dispersion of the additive.

The shear viscosity of Examples 6, 10, 12 and 13 and unmodified polypropylene were measured using a capillary rheometer according to ASTM D3835 at 230° C. using a 30:1 capillary. FIG. 1 shows the neat PP resin compared with Examples 6, 10, 12 and 13.

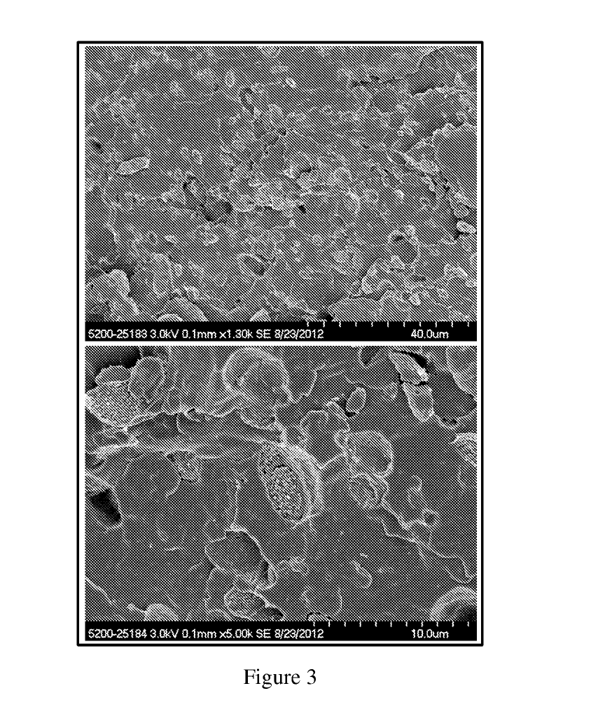

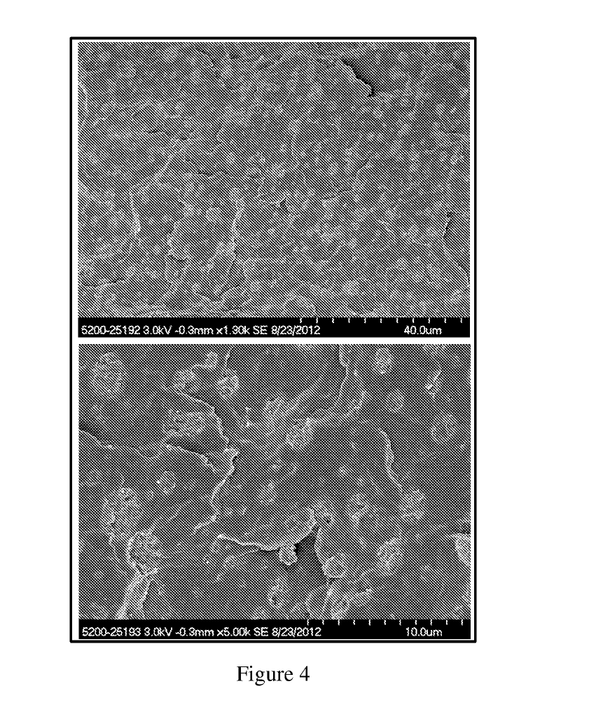

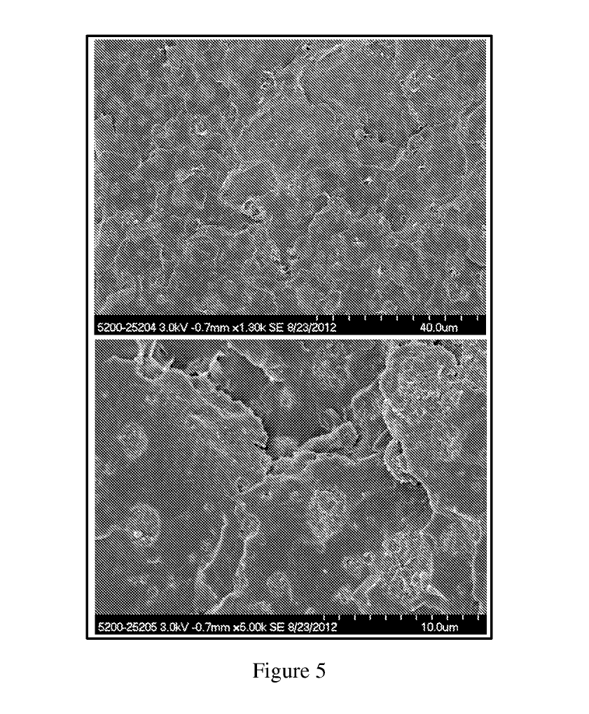

FIG. 2-5 shows SEM images for Examples 6, 10, 12 and 13, showing the pore size, or dispersion of the oil within the polypropylene polymer. Sample preparation was as follows.

Freeze Fracture Procedure: 1) The pellets were immersed in liquid nitrogen and were allowed to cool down until any boiling reached a minimum. 2) The bottom inch or so of a standard woodworking chisel was also immersed in liquid nitrogen and allowed to cool down until any boiling reached a minimum. 3) The pellets were then fractured across the cylinder by placing the chisel on the pellet and tapping it with a hammer 4) The fragments were removed from the liquid nitrogen and allowed to warm up while sitting on the lab bench.

Extraction Procedure: Hexane 1) Approximately 15 ml of Hexanes (Mallinckrodt Chemicals, Cat#H487-10) was placed into a glass vial. The fractured pellets were added to solvent and a cap put on the vial. The fractured pellets were soaked in the solvent. Occasionally, the vial was shaken by hand. 2) After 30 minutes the fractured pellets were removed from the solvent and allowed to dry.

Mounting and Coating Procedure: 1) A piece of double sided carbon tape (Electron Microscopy Sciences, Cat#77825-12) was affixed to the sample stub. The fractured pellet was then affixed to the top of the tape trying to keep the fracture surface pointed up and as parallel to the surface of the stub as possible. 2) The sample was then mounted in the SEM holder for the Hitachi S-5200 Scanning Electron Microscope and loaded into the Gatan Alto 2500 coated and coated for 90 seconds at 10 mA current with gold/palladium (Refining Systems Inc., Gold Palladium Target, 1″ Diameter×0.010″ Thick). Argon gas (Matheson Tri-Gas, Ultra-High Purity) was used.

Imaging: Imaging was performed in the Hitachi S-5200 Scanning Electron Microscope at 3 KV accelerating voltage and 5-10 μA tip current.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A polymer-soap composition comprising an intimate admixture of
(a) a thermoplastic polymer; and
(b) a soap;
wherein said soap has a droplet size of less than 10 μm within the thermoplastic polymer.

2. The composition of claim 1, wherein the droplet size is less than 5 μm.

3. The composition of claim 1, wherein the droplet size is less than 1 μm.

4. The composition of claim 1, wherein the droplet size is less than 500 nm.

5. The composition of claim 1, further comprising an additive, wherein said additive is soap soluble or soap dispersible

6. The composition of claim 5, wherein the additive is a perfume, dye, pigment, nanoparticle, antistatic agent, filler, or combination thereof.

7. The composition of claim 1, having a biobased content of greater than 3%.

8. The composition of claim 1, comprising from 5 wt % to 60 wt % soap, based upon the total weight of the composition.

9. The composition of claim 1, comprising from 8 wt % to 40 wt % soap, based upon the total weight of the composition.

10. The composition of claim 1, comprising from 10 wt % to 30 wt % soap, based upon the total weight of the composition

11. The composition of claim 1, wherein said soap comprises a fatty acid selected from the group consisting of lauric, myristic, palmitic, stearic, oleic, linoleic, linolenic, and combinations thereof.

12. The composition of claim 1, wherein said soap comprises a metal salt where the, metal is selected from the group consisting of sodium, potassium, rubidium, cesium, silver, cobalt, nickel, copper, manganese, iron, chromium, lithium, lead, thallium, mercury, thorium, beryllium, and combinations thereof.

13. The composition of claim 1, wherein said soap comprises calcium stearate, magnesium stearate, zinc stearate, or combinations thereof.

14. The composition of claim 1, wherein the thermoplastic polymer comprises a polyolefin, a polyester, a polyamide, copolymers thereof, or combinations thereof.

15. The composition of claim 1, wherein the thermoplastic polymer comprises polypropylene, polyethylene, polypropylene co-polymer, polyethylene co-polymer, polyethylene terephthalate, polybutylene terephthalate, polylactic acid, polyhydroxyalkanoates, polyamide-6, polyamide-6,6, or combinations thereof.

16. The composition of claim 1, wherein the thermoplastic polymer comprises polypropylene.

17. The composition of claim 16, wherein said polypropylene has a weight average molecular weight of 20 kDa to 400 kDa.

18. The composition of claim 16, wherein the polypropylene has a melt flow index of greater than 5 g/10 min.

19. The composition of claim 16, wherein the polypropylene has a melt flow index of greater than 10 g/10 min.

20. The composition of claim 1 in the form of pellets.

21. The composition of claim 1 further comprising a nucleating agent.

22. A method of making the polymer-soap composition of claim 1, comprising the steps:
a) mixing, in a molten state, the thermoplastic polymer and the soap to form an intimate admixture; and
b) cooling the intimate admixture in 10 seconds or less to a temperature equal to or less than the solidification temperature of the thermoplastic polymer to form a solid polymer-soap composition.

23. A method of making a polymer-soap composition, comprising the steps:
a) mixing, in a molten state, the thermoplastic polymer and the soap to form an intimate admixture; and
b) cooling the intimate admixture in 10 seconds or less to a temperature equal to or less than the solidification temperature of the thermoplastic polymer to form a solid polymer-soap composition.

24. The method of claim 23, wherein said mixing step comprises mixing with a shear rate greater than 10 s⁻¹.

25. The method of claim 24, wherein the shear rate is from 30 to 100 s⁻¹.

26. The method of claim 23, wherein said mixing step comprises mixing with an extruder.

27. The method of claim 26, wherein said extruder is a single screw extruder or a twin screw extruder.

28. The method of claim 23, wherein said cooling step comprises cooling the admixture in 10 seconds or less to a temperature of 50° C. or less.

29. The method of claim 23, additionally comprising the step of pelletizing the admixture.

30. The method of claim 29, wherein said pelletizing step occurs before, after, or simultaneously with the cooling step.

31. A polymer-soap composition comprising an additive, wherein said composition is prepared by a method comprising the steps:
a) mixing, in a molten state, the thermoplastic polymer and the soap to form an intimate admixture; and
b) cooling the intimate admixture in 10 seconds or less to a temperature equal to or less than the solidification temperature of the thermoplastic polymer to form a solid polymer-soap composition;
wherein said method does not comprise the step of removing said additive, and further wherein said additive is soap soluble or soap miscible.

32. The polymer-soap composition of claim 1 having a bio-based content of from 30-100%.

33. The polymer-soap composition of claim 22 having a bio-based content of from 30-100%.

34. The polymer-soap composition of claim 23 having a bio-based content of from 30-100%.

35. The polymer-soap composition of claim 31 having a bio-based content of from 30-100%.

36. The composition of claim 1, wherein said intimate admixture of a thermoplastic polymer and soap functions as a compatibilizer.

37. The composition of claim 1 compatibilized by an intimate admixture of a thermoplastic polymer and soap.
